(19) United States
(12) Patent Application Publication
(10) Pub. No.: US 2007/0160486 A1
(43) Pub. Date: Jul. 12, 2007

(54) Rotary compressor

(76) Inventors: Sam Chul Ha, Gyeongsangnam-do (KR); Ji Young Bae, Busan (KR); Kyoung Jun Park, Geongsangnam-do (KR); Chang Yong Jang, Gwangju (KR); Hyeon Kim, Gyeongsangnam-do (KR)

Correspondence Address: KED & ASSOCIATES, LLP, P.O. Box 221200, Chantilly, VA, 20153-1200, US

(21) Appl. No.: 10/560,084

(22) PCT Filed: May 3, 2004
(86) PCT No.: PCT/KR04/01029

§ 371 Date: Jan. 23, 2007

(30) Foreign Application Priority Data
Jun. 11, 2003 (KR) 10-2003-0037658

(51) Int. Cl. F01C 20/18; F16N 13/20; F04C 29/00; F04C 14/18; F01C 1/02

(52) U.S. Cl. 418/32; 418/63; 418/270

(57) ABSTRACT

Disclosed is a rotary compressor having two compression capacities in clockwise and counterclockwise directions. The rotary compressor includes: a driving shaft (13) being rotatable clockwise and counterclockwise, and having an eccentric portion (13a) of a predetermined size; a cylinder (21) having a predetermined inner volume; roller (22) installed rotatably on an outer circumference of the eccentric portion (13a) so as to contact an inner circumference of the cylinder, performing a rolling motion along the inner circumference and forming a fluid chamber (29) to suck and compress fluid along with the inner circumference; a vane (23) installed elastically in the cylinder to contact the roller; upper and lower bearings (24, 25) installed respectively in upper and lower portions of the cylinder (21), for rotatably supporting the driving shaft (13) and hermetically sealing the inner volume; suction (27) and discharge ports (26) communicating with the fluid chamber (29) depending on the rotational direction of the driving shaft (13).

### TECHNICAL FIELD

The present invention relates to a rotary compressor, and more particularly, to a mechanism for changing compression capacity of a rotary compressor.

### BACKGROUND ART

In general, compressors are machines that are supplied power from a power generator such as electric motor, turbine or the like and apply compressive work to a working fluid, such as air or refrigerant to elevate the pressure of the working fluid. Such compressors are widely used in a variety of applications, from electric home appliances such as air conditioners, refrigerators and the like to industrial plants.

The compressors are classified into two types according to their compressing methods: a positive displacement compressor, and a dynamic compressor (a turbo compressor). The positive displacement compressor is widely used in industry fields and configured to increase pressure by reducing its volume. The positive displacement compressors can be further classified into a reciprocating compressor and a rotary compressor.

The reciprocating compressor is configured to compress the working fluid using a piston that linearly reciprocates in a cylinder. The reciprocating compressor has an advantage of providing high compression efficiency with a simple structure. However, the reciprocation compressor has a limitation in increasing its rotational speed due to the inertia of the piston and a disadvantage in that a considerable vibration occurs due to the inertial force. The rotary compressor is configured to compress working fluid using a roller eccentrically revolving along an inner circumference of the cylinder, and has an advantage of obtaining high compression efficiency at a low speed compared with the reciprocating compressor, thereby reducing noise and vibration.

Recently, compressors having at least two compression capacities have been developed. These compressors have compression capacities different from each other according to the rotational directions (i.e., clockwise direction and counterclockwise direction) by using a partially modified compression mechanism. Since compression capacity can be adjusted differently according to loads required by these compressors, such a compressor is widely used to increase an operation efficiency of several equipments requiring the compression of working fluid, especially household electric appliances such as a refrigerator that uses a refrigeration cycle.

However, a conventional rotary compressor has separately a suction portion and a discharge portion which communicate with a cylinder. The roller rolls from the suction port to the discharge portion along an inner circumference of the cylinder, so that the working fluid is compressed. Accordingly, when the roller rolls in an opposite direction (i.e., from the discharge portion to the suction portion), the working fluid is not compressed. In other words, the conventional rotary compressor cannot have different compression capacities if the rotational direction is changed. Accordingly, there is a demand for a rotary compressor having variable compression capacities as well as the aforementioned advantages.

### DISCLOSURE OF INVENTION

Accordingly, the present invention is directed to a rotary compressor that substantially obviates one or more problems due to limitations and disadvantages of the related art.

An object of the present invention is to provide a rotary compressor in which the compressing stroke is possibly performed to both of the clockwise and counterclockwise rotations of a driving shaft.

Another object of the present invention is to provide a rotary compressor whose compression capacity can be varied.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, there is provided a rotary compressor having two compression capacities in clockwise and counterclockwise directions. The rotary compressor includes: a driving shaft being rotatable clockwise and counterclockwise, and having an eccentric portion of a predetermined size; a cylinder having a predetermined inner volume; a roller installed rotatably on an outer circumference of the eccentric portion so as to contact an inner circumference of the cylinder, performing a rolling motion along the inner circumference and forming a fluid chamber to suck and compress fluid along with the inner circumference; a vane installed elastically in the cylinder to contact the roller; upper and lower bearings installed respectively in upper and lower portions of the cylinder, for rotatably supporting the driving shaft and hermetically sealing the inner volume; suction and discharge ports communicating with the fluid chamber so as to suck and discharge the fluid; and a compression mechanism configured to form different sizes of compressive spaces in the fluid chamber depending on the rotational direction of the driving shaft.

Preferably, the compression mechanism compresses the fluid using the overall fluid chamber when the driving shaft rotates in any one of the clockwise direction and the counterclockwise direction.

In more detail, the compression mechanism compresses the fluid using a portion of the fluid chamber when the driving shaft rotates in the other of the clockwise direction and the counterclockwise direction.

In an aspect of the invention, the compression mechanism comprises a valve assembly, which rotates according to the rotational direction of the driving shaft to selectively open at least one of the suction ports.

In another aspect of the invention, the compression mechanism comprises a valve assembly selective opening at least one of the suction ports spaced apart from each other by using a pressure difference between the cylinder and inner and outer portions according to the rotational direction of the driving shaft.

In still another aspect of the invention, the compression mechanism comprises a first vane and a second vane that divide the fluid chamber into a first space configured such that the fluid is compressed while the driving shaft rotates bidirectionally, and a second space configured such that the fluid is compressed while the driving shaft rotates in any one direction.

In yet another aspect of the invention, the compression mechanism is comprised of clearances formed differently according to the rotational direction of the driving shaft between the roller and the inner circumference of the cylinder.

It is to be understood that both the foregoing general description and the following detailed description of the present invention are exemplary and explanatory and are intended to provide further explanation of the invention as claimed.

### BRIEF DESCRIPTION OF DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a partial longitudinal sectional view illustrating a rotary compressor according to a first embodiment of the present invention;

FIG. 2 is an exploded perspective view illustrating the compression unit of the rotary compressor according to a first embodiment of the present invention;

FIG. 3 is a sectional view illustrating the compressing unit according to a first embodiment of the present invention;

FIG. 4 is a cross-sectional view illustrating the inside of the cylinder according to a first embodiment of the present invention;

FIGS. 5A and 5B are plan views illustrating a lower bearing of the rotary compressor according to a first embodiment of the present invention;

FIG. 6 is a plan view illustrating a valve assembly of the rotary compressor according to a first embodiment of the present invention;

FIGS. 7A and 7C are plan views illustrating modifications of a valve assembly;

FIGS. 8A and 8B are plan views illustrating a revolution control means;

FIG. 8C is a partial sectional view of FIG. 8B;

FIGS. 9A and 9B are plan views of modifications of the revolution control means of the valve assembly;

FIGS. 10A and 10B are plan views of another modifications of the revolution control means of the valve assembly;

FIGS. 11A and 11B are plan views of another modifications of the revolution control means of the valve assembly;

FIGS. 12A to 12C are cross-sectional views sequentially illustrating insides of the cylinder when the roller revolves in the counterclockwise direction in the rotary compressors according to a first embodiment of the present invention;

FIGS. 13A to 13C are cross-sectional views sequentially illustrating insides of the cylinder when the roller revolves in the clockwise direction in the rotary compressors according to a first embodiment of the present invention;

FIG. 14 is a partial longitudinal sectional view illustrating a rotary compressor according to a second embodiment of the present invention;

FIG. 15 is an exploded perspective view illustrating the compression unit of the rotary compressor according to a second embodiment of the present invention;

FIG. 16 is a sectional view illustrating the compressing unit according to a second embodiment of the present invention;

FIG. 17 is a cross-sectional view illustrating the inside of the cylinder according to a second embodiment of the present invention;

FIG. 18 is a plan view illustrating a lower bearing of the rotary compressor according to a second embodiment of the present invention;

FIG. 19 is an exploded perspective view of a rotary compressor including a modified valve assembly according to a second embodiment of the present invention;

FIG. 20 is a plan view illustrating the valve assembly of FIG. 6;

FIGS. 21A and 21B are sectional views illustrating operation of discharge valves of a rotary compressor according to a second embodiment of the present invention;

FIGS. 22A and 23B are sectional views illustrating operation of a valve assembly of a rotary compressor according to a second embodiment of the present invention;

FIGS. 23A to 23C are cross-sectional views sequentially illustrating insides of the cylinder when the roller revolves in the counterclockwise direction in the rotary compressors according to a second embodiment of the present invention;

FIGS. 24A to 24C are cross-sectional views sequentially illustrating insides of the cylinder when the roller revolves in the clockwise direction in the rotary compressors according to a second embodiment of the present invention;

FIG. 25 is a partial longitudinal sectional view illustrating a rotary compressor according to a third embodiment of the present invention;

FIG. 26 is an exploded perspective view illustrating the compression unit of the rotary compressor according to a third embodiment of the present invention;

FIG. 27 is a sectional view illustrating the compressing unit according to a third embodiment of the present invention;

FIG. 28 is a cross-sectional view illustrating the inside of the cylinder according to a third embodiment of the present invention;

FIG. 29 is a plan view illustrating a lower bearing of the rotary compressor according to a third embodiment of the present invention;

FIGS. 30A and 30B are sectional views illustrating operation of discharge valves of a rotary compressor according to a third embodiment of the present invention;

FIGS. 31A and 32B are sectional views illustrating operation of suction valves of a rotary compressor according to a third embodiment of the present invention;

FIGS. 32A to 32D are cross-sectional views sequentially illustrating insides of the cylinder when the roller revolves in the counterclockwise direction in the rotary compressors according to a third embodiment of the present invention;

FIGS. 33A to 33D are cross-sectional views sequentially illustrating insides of the cylinder when the roller revolves in the clockwise direction in the rotary compressors according to a third embodiment of the present invention;

FIG. 34 is a partial longitudinal sectional view illustrating a rotary compressor according to a fourth embodiment of the present invention;

FIG. 35 is an exploded perspective view illustrating the compression unit of the rotary compressor according to a fourth embodiment of the present invention;

FIG. 36 is a sectional view illustrating the compressing unit according to a fourth embodiment of the present invention;

FIG. 37 is a cross-sectional view illustrating the inside of the cylinder according to a fourth embodiment of the present invention;

FIG. 38 is a plan view illustrating clearances between the roller and the cylinder in a rotary compressor according to a fourth embodiment of the present invention;

FIGS. 39A to 39C are cross-sectional views sequentially illustrating insides of the cylinder when the roller revolves in the counterclockwise direction in the rotary compressors according to a fourth embodiment of the present invention; and

FIGS. 40A to 40C are cross-sectional views sequentially illustrating insides of the cylinder when the roller revolves in the clockwise direction in the rotary compressors according to a fourth embodiment of the present invention.

### BEST MODE FOR CARRYING OUT THE INVENTION

Reference will now be made in detail to the preferred embodiments of the present invention to achieve the objects, with examples of which are illustrated in the accompanying drawings. Wherever possible, the same reference numbers will be used throughout the drawings to refer to the same or like parts.

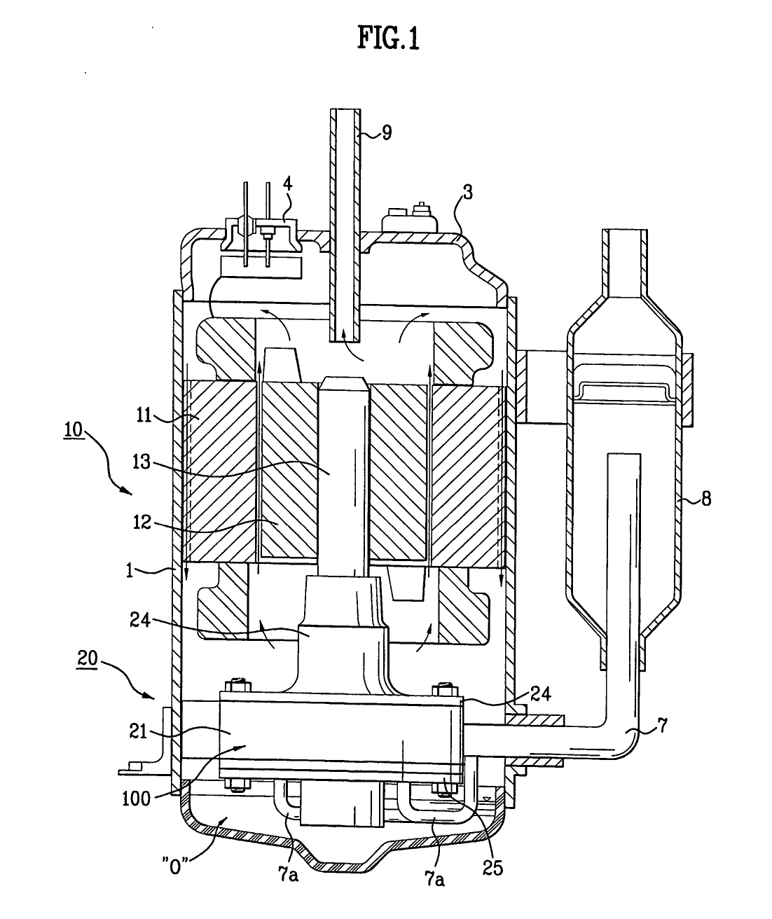

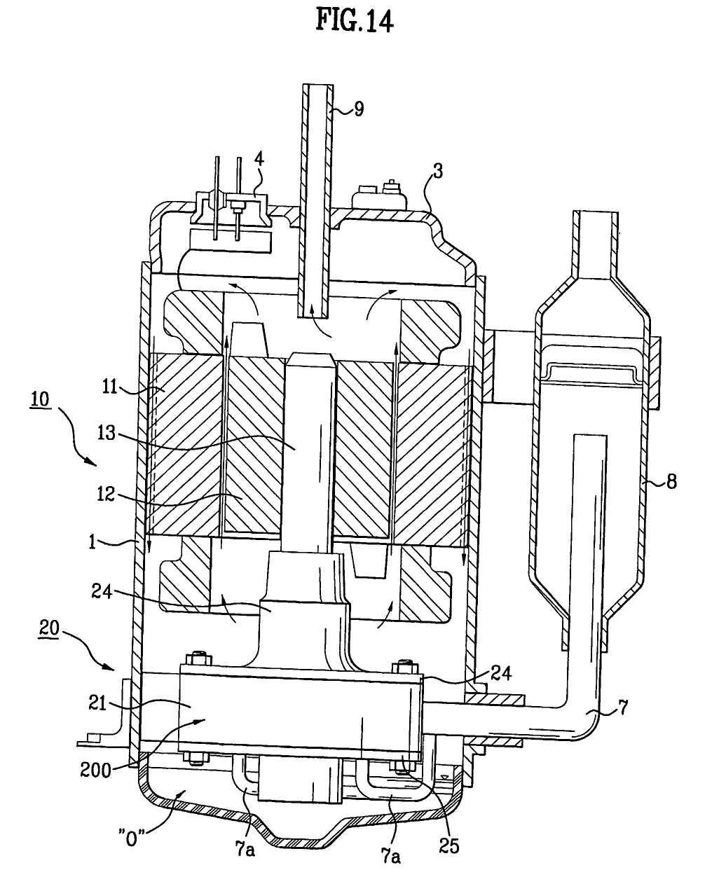

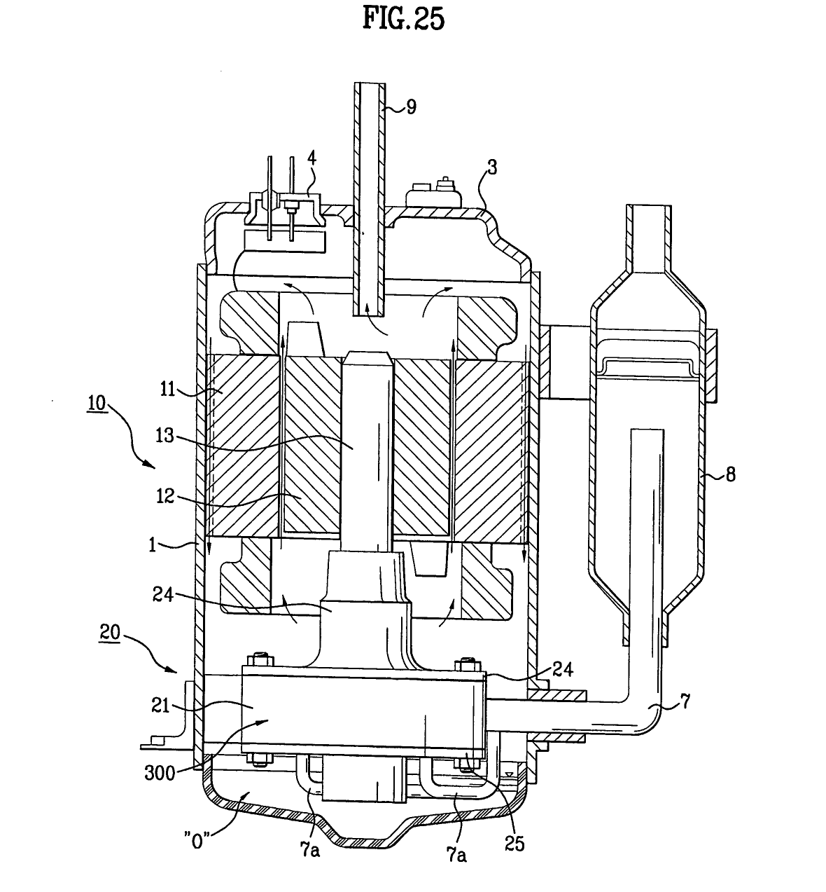

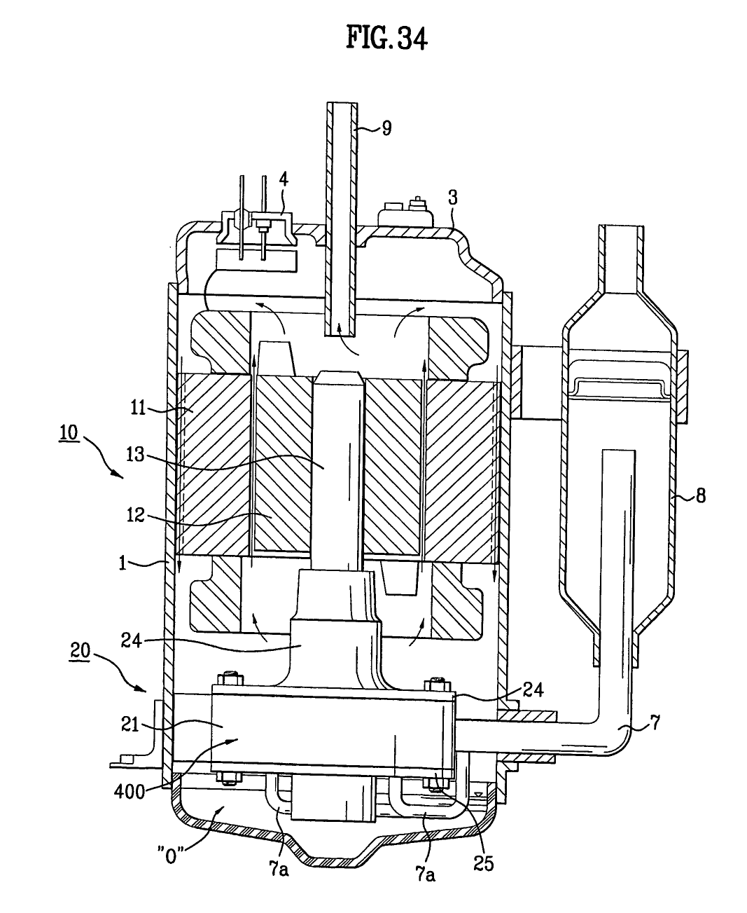

FIGS. 1, 14, 25 and 34 are longitudinal sectional views of rotary compressors according to first to fourth embodiments of the present invention.

First, as shown in the drawings, in each embodiment, a rotary compressor of the present invention includes a case 1, a power generator 10 positioned in the case 1 and a compressing unit 20. In the referenced figures, the power generator 10 is positioned on the upper portion of the rotary compressor and the compressing unit 20 is positioned on the lower portion of the rotary compressor. However, their positions may be changed if necessary. An upper cap 3 and a lower cap 5 are installed on the upper portion and the lower portion of the case 1 respectively to define a sealed inner space. A suction pipe 7 for sucking working fluid is installed on a side of the case 1 and connected to an accumulator 8 for separating lubricant from refrigerant. A discharge pipe 9 for discharging the compressed fluid is installed on the center of the upper cap 3. A predetermined amount of the lubricant “0” is filled in the lower cap 5 so as to lubricate and cool members that are moving frictionally. Here, an end of a driving shaft 13 is dipped in the lubricant.

The power generator 10 includes a stator 11 fixed in the case 1, a rotor 12 rotatable supported in the stator 11 and the driving shaft 13 inserted forcibly into the rotor 12. The rotor 12 is rotated due to electromagnetic force, and the driving shaft 13 delivers the rotation force of the rotor to the compressing unit 20. To supply external electric power to the stator 20, a terminal 4 is installed in the upper cap 3. In the present invention, the rotor 12 is configured to be rotatable clockwise and counterclockwise and accordingly the driving shaft 13 is rotatable along with the rotor 12 bidirectionally, i.e., clockwise and counterclockwise. Since the bidirectionally rotatable motor is conventional, its detailed description will be omitted.

The compressing unit 20 includes a cylinder 21 fixed to the case 1, and upper and lower bearings 24 and 25 respectively installed on upper and lower portions of the cylinder 21. Also, other elements for compression are included in the cylinder 21 and bearings 24 and 25, and combination of a part of the elements constitutes compression mechanisms 100, 200, 300 and 400 in each embodiment.

In the compression unit 20, the compression mechanisms 100, 200, 300 and 400 compress specific working fluid in all rotational directions (clockwise and counterclockwise) of the driving shaft 13 in combination with other elements. For instance, for bidirectional compression, in addition to the compression mechanisms, the aforementioned bidirectional rotational motor is applied to the compressor of the invention, and suction and discharge ports allow the fluid to be sucked into the compression unit 20 and to be discharged from the compression unit 20 in all rotational directions of the driving shaft 13. Further, the compression mechanisms 100, 200, 300 and 400 are configured to form compression spaces having different sizes substantially inside the compression unit 20 according to the rotational direction of the driving shaft 13. Accordingly, the compressor is allowed to have different compression capacities according to the rotational directions of the shaft 13.

In the rotary compressor of the invention, the power generator 10 is the same as that of a general rotary compressor, and any great modification is not required for the power generator 10 according to the embodiments of the invention. Accordingly, additional description on the power generator 10 is omitted and the compression mechanisms 100, 200, 300 and 400 schematically described in the above will be described in more detail with reference to drawings related with first to fourth embodiments.

### First Embodiment

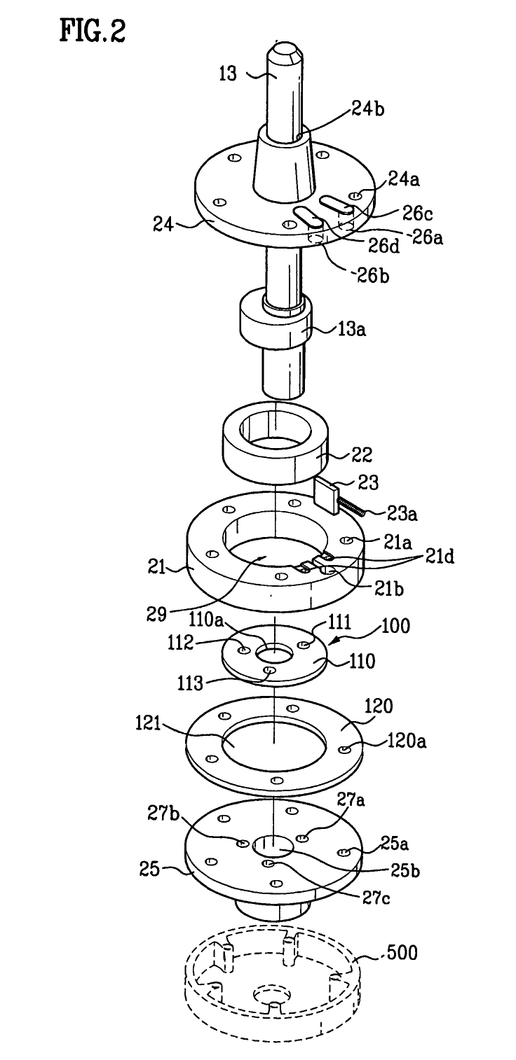

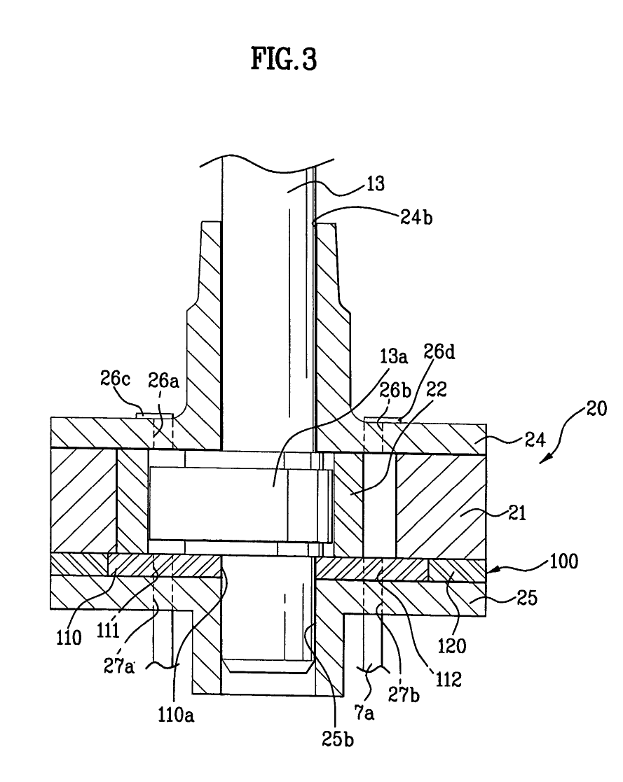

FIG. 2 is an exploded perspective view illustrating the compression unit of the rotary compressor according to a first embodiment of the present invention and FIG. 3 is a sectional view illustrating the compressing unit according to a first embodiment of the present invention.

In the compression unit 20 of the first embodiment, the cylinder 21 has a predetermined inner volume and a strength enough to endure the pressure of the fluid. The cylinder 21 accommodates an eccentric portion 13a formed on the driving shaft 13 in the inner volume. The eccentric portion 13a is a kind of an eccentric cam and has a center spaced by a predetermined distance from its rotation center. The cylinder 21 has a groove 21b extending by a predetermined depth from its inner circumference. A vane 23 to be described below is installed in the groove 21b. The groove 21b is long enough to accommodate the vane 23 completely.

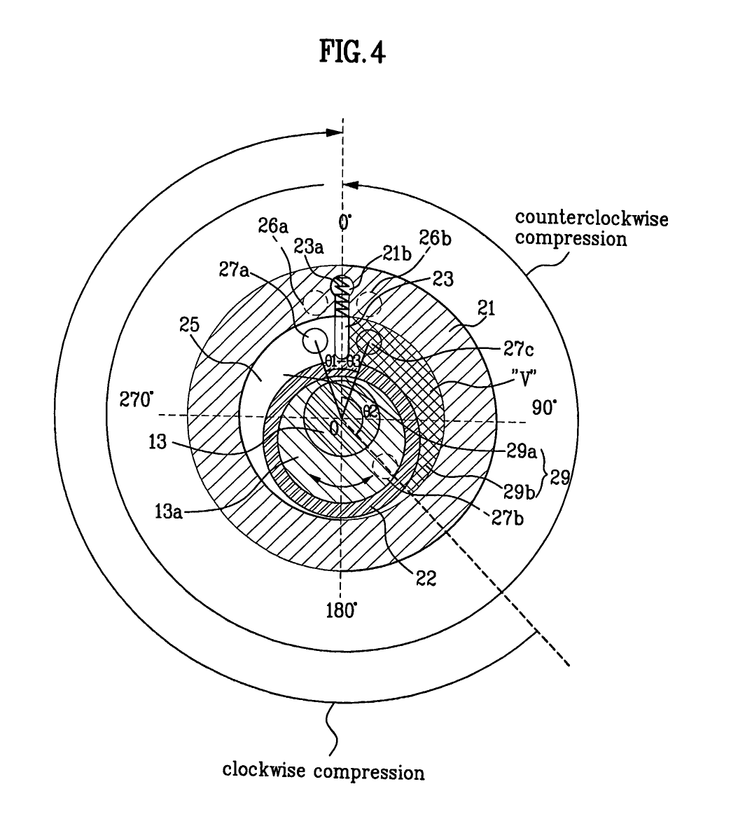

The roller 22 is a ring member that has an outer diameter less than the inner diameter of the cylinder 21. As shown in FIG. 4, the roller 22 contacts the inner circumference of the cylinder 21 and rotatably coupled with the eccentric portion 13a. Accordingly, the roller 22 performs rolling motion on the inner circumference of the cylinder 21 while spinning on the outer circumference of the eccentric portion 13a when the driving shaft 13 rotates. The roller 22 revolves spaced apart by a predetermined distance from the rotation center ‘0’ due to the eccentric portion 13a while performing the rolling motion. Since the outer circumference of the roller 22 always contacts the inner circumference due to the eccentric portion 13a, the outer circumference of the roller 22 and the inner circumference of the cylinder form a separate fluid chamber 29 in the inner volume. The fluid chamber 29 is used to suck and compress the fluid in the rotary compressor.

The vane 23 is installed in the groove 21b of the cylinder 21 as described above. An elastic member 23a is installed in the groove 21b to elastically support the vane 23. The vane 23 continuously contacts the roller 22. In other words, the elastic member 23a has one end fixed to the cylinder 21 and the other end coupled with the vane 23, and pushes the vane 23 to the side of the roller 22. Accordingly, the vane 23 divides the fluid chamber 29 into two separate spaces 29a and 29b as shown in FIG. 4. While the driving shaft 13 rotate or the roller 22 revolves, the volumes of the spaces 29a and 29b are changed complementarily. In other words, if the roller 22 rotates clockwise, the space 29a gets smaller but the other space 29b gets larger. However, the total volume of the spaces 29a and 29b is constant and approximately same as that of the predetermined fluid chamber 29. One of the spaces 29a and 29b works as a suction chamber for sucking the fluid and the other one works as a compression chamber for compressing the fluid relatively when the driving shaft 13 rotates in one direction (clockwise or counterclockwise). Accordingly, as described above, the compression chamber of the spaces 29a and 29b gets smaller to compress the previously sucked fluid and the suction chamber expands to suck the new fluid relatively according to the rotation of the roller 22. If the rotational direction of the roller 22 is reversed, the functions of the spaces 29a and 29b are exchanged. In the other words, if the roller 22 revolves counterclockwise, the right space 29b of the roller 22 becomes a compression chamber, but if the roller 22 revolves clockwise, the left space 29a of the roller 22 becomes a discharge unit.

The upper bearing 24 and the lower bearing 25 are, as shown in FIG. 2, installed on the upper and lower portions of the cylinder 21 respectively, and rotatably support the driving shaft 12 using a sleeve and the penetrating holes 24b and 25b formed inside the sleeve. In more detail, the upper bearing 24, the lower bearing 25 and the cylinder 21 include a plurality of coupling holes 24a, 25a and 21a formed to correspond to each other respectively. The cylinder 21, the upper bearing 24 and the lower bearing 25 are coupled with one another to seal the cylinder inner volume, especially the fluid chamber 29 using coupling members such as bolts and nuts.

The discharge ports 26a and 26b are formed on the upper bearing 24. The discharge ports 26a and 26b communicate with the fluid chamber 29 so that the compressed fluid can be discharged. The discharge ports 26a and 26b can communicate directly with the fluid chamber 29 or can communicate with the fluid chamber 29 through a predetermined fluid passage 21d formed in the cylinder 21 and the upper bearing 24. Discharge valves 26c and 26d are installed on the upper bearing 24 so as to open and close the discharge ports 26a and 26b. The discharge valves 26c and 26d selectively open the discharge ports 26a and 26b only when the pressure of the chamber 29 is greater than or equal to a predetermined pressure. To achieve this, it is desirable that the discharge valves 26c and 26d are leaf springs of which one end is fixed in the vicinity of the discharge ports 26a and 26b and the other end can be deformed freely. Although not shown in the drawings, a retainer for restricting the deformable amount of the leaf spring may be installed on the upper portion of the discharge valves 26c and 26d so that the valves can operate stably. In addition, a muffler (not shown) can be installed on the upper portion of the upper bearing 24 to reduce a noise generated when the compressed fluid is discharged.

The suction ports 27a, 27b and 27c communicating with the fluid chamber 29 are formed on the lower bearing 25. The suction ports 27a, 27b and 27c guide the compressed fluid to the fluid chamber 29. The suction ports 27a, 27b and 27c are connected to the suction pipe 7 so that the fluid outside the compressor can flow into the chamber 29. More particularly, the suction pipe 7 is branched into a plurality of auxiliary pipes 7a and the branched auxiliary pipes 7a are connected to suction ports 27 respectively. If necessary, the discharge ports 26a, and 26b may be formed on the lower bearing 25 and the suction ports 27a, 27b and 27c may be formed on the upper bearing 24.

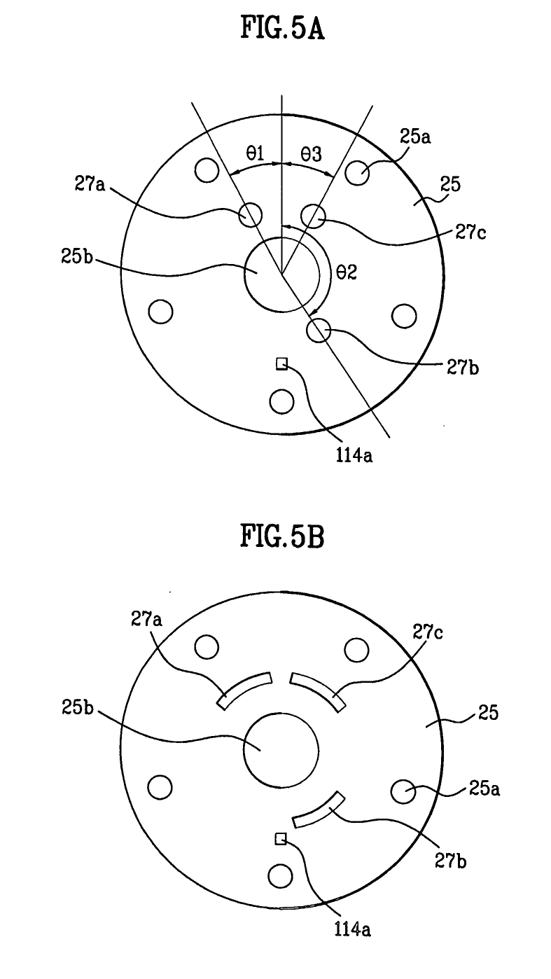

The suction and discharge ports 26 and 27 become the important factors in determining compression capacity of the rotary compressor, and will be described referring to FIGS. 4 and 5. FIG. 4 is a cross-sectional view illustrating the inside of the cylinder according to a first embodiment of the present invention.

First, the compressor of the present invention includes at least two discharge ports 26a and 26b. As shown in the drawing, even if the roller 22 revolves in any direction, a discharge port should exist between the suction port and vane 23 positioned in the revolution path to discharge the compressed fluid. Accordingly, one discharge port is necessary for each rotational direction. It causes the compressor of the present invention to discharge the fluid regardless of the revolution direction of the roller 22 (that is, the rotational direction of the driving shaft 13). Meanwhile, as described above, the compression chamber of the spaces 29a and 29b gets smaller to compress the fluid as the roller 22 approaches the vane 23. Accordingly, the discharge ports 26a and 26b are preferably formed facing each other in the vicinity of the vane 23 to discharge the maximum compressed fluid. In other word, as shown in the drawings, the discharge ports 26a and 26b are positioned on both sides of the vane 23 respectively. The discharge ports 26a and 26b are preferably positioned in the vicinity of the vane 23 if possible.

The suction port 27 is positioned properly so that the fluid can be compressed between the discharge ports 26a and 26b and the roller 22. Actually, the fluid is compressed from a suction port to a discharge port positioned in the revolution path of the roller 22. In other words, the relative position of the suction port for the corresponding discharge port determines the compression capacity and accordingly two compression capacities can be obtained using different suction ports 27 according to the rotational direction. Accordingly, the compression of the present invention has first and second suction ports 27a and 27b corresponding to two discharge ports 26a and 26b respectively and the suction ports are spaced apart by a predetermined angle from each other with respect to the center 0 for two different compression capacities.

Preferably, the first suction port 27a is positioned in the vicinity of the vane 23. Accordingly, the roller 22 compresses the fluid from the first suction port 27a to the second discharge port 26b positioned across the vane 23 in its rotation in one direction (counterclockwise in the drawing). The roller 22 compress the fluid due to the first suction port 27a by using the overall chamber 29 and accordingly the compressor has a maximum compression capacity in the counterclockwise rotation. In other words, the fluid as much as overall volume of the chamber 29 is compressed. The first suction port 27a is actually spaced apart by an angle θ1 of 10° clockwise or counterclockwise from the vane 23 as shown in FIGS. 4 and 5A. The drawings of the present invention illustrates the first suction port 27a spaced apart by the angle θ1 counterclockwise. At this separating angle θ1, the overall fluid chamber 29 can be used to compress the fluid without interference of the vane 23.

The second suction port 27b is spaced apart by a predetermined angle from the first suction port 27a with respect to the center. The roller 20 compresses the fluid from the second suction port 27b to the first discharge port 26a in its rotation in counterclockwise direction. Since the second suction port 27b is spaced apart by a considerable angle clockwise from the vane 23, the roller 22 compresses the fluid by using a portion of the chamber 29 and accordingly the compressor has the less compression capacity than that of counterclockwise rotary motion. In other words, the fluid as much as a portion volume of the chamber 29 is compressed. The second suction port 27b is preferably spaced apart by an angle θ2 of a range of 90-180° clockwise or counterclockwise from the vane 23. The second suction port 27b is preferably positioned facing the first suction port 27a so that the difference between compression capacities can be made properly and the interference can be avoid for each rotational direction.

As shown in FIG. 5A, the suction ports 27a and 27b are generally in circular shapes whose diameters are, preferably, 6-15 mm. In order to increase a suction amount of fluid, the suction ports 27a and 27b can also be provided in several shapes, including a rectangle. Further, as shown in FIG. 5B, the rectangular suction ports 27a and 27b may have a predetermined curvature. In this case, an interference with adjacent other parts, especially the roller 22, can be minimized in operation.

Meanwhile, in order to obtain desired compression capacity in each rotational direction, suction ports that are available in any one of rotational directions should be single. If there are two suction ports in rotation path of the roller 22, the compression does not occur between the suction ports. In other words, if the first suction port 27a is opened, the second suction port 27b should be closed, and vice versa. Accordingly, the valve assembly 100 is installed between the lower bearing 24 and the cylinder 21 to selectively open only one of the suction ports 27a and 27b according to the revolution direction (i.e., rotational direction of the driving shaft 13). Thus, by selectively opening a specific one of the suction ports, different compression spaces can be substantially formed in the fluid chamber 29 according to the rotational direction, so that the valve assembly 100 acts as the inventive compression mechanism previously defined.

As shown in FIGS. 2, 3 and 6, the valve assembly 100 includes first and second valves 110 and 120, which are installed between the cylinder 21 and the lower bearing 25 so as to allow it to be adjacent to the suction ports. If the suction ports 27a, 27b and 27c are formed on the upper bearing 24, the first and second valves 110 and 120 are installed between the cylinder 21 and the upper bearing 24.

The first valve 110, as shown in FIG. 3, is a disk member installed so as to contact the eccentric portion 13a more accurately than the driving shaft 13. Accordingly, if the driving shaft 13 rotates (that is, the roller 22 revolves), the first valve 110 rotates in the same direction. Preferably, the first valve 110 has a diameter larger than an inner diameter of the cylinder 21. As shown in FIG. 3, the cylinder 21 supports a portion (i.e., an outer circumference) of the first valve 110 so that the first valve 110 can rotate stably. Preferably, the first valve 110 is 0.5-5 mm thick.

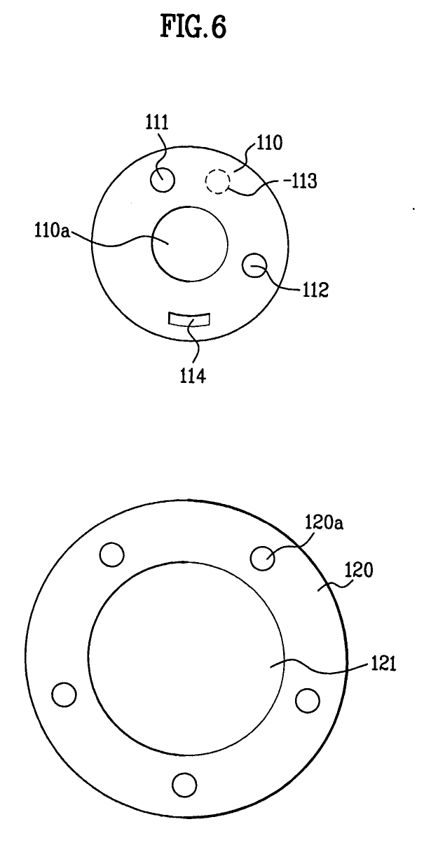

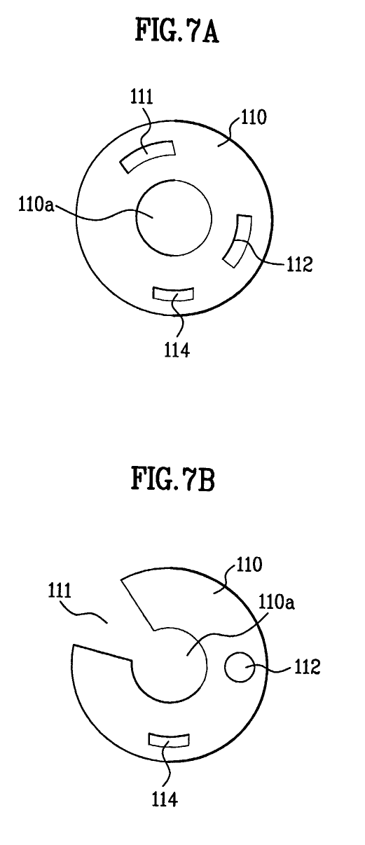

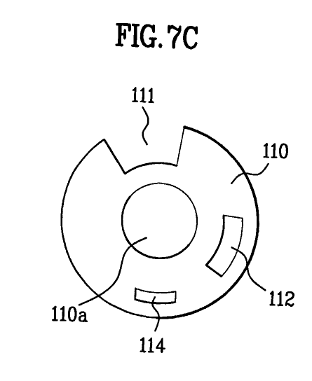

Referring to FIGS. 2 and 6, the first valve 110 includes first and second openings 111 and 112 respectively communicating with the first and second suction ports 27a and 27b in specific rotational direction, and a penetration hole 110a into which the driving shaft 13 is inserted. In more detail, when the roller 22 rotates in any one of the clockwise and counterclockwise directions, the first opening 111 communicates with the first suction port 27a by the rotation of the first valve 110, and the second suction port 27b is closed by the body of the first valve 110. When the roller 22 rotates in the other of the clockwise and counterclockwise directions, the second opening 112 communicates with the second suction port 27b. At this time, the first suction port 27a is closed by the body of the first valve 110. These first and second openings 111 and 112 can be in circular or polygonal shapes. In case the openings 111 and 112 are the circular shapes, it is desired that the openings 111 and 112 are 6-15 mm in diameter. Additionally, the openings 111 and 112 can be rectangular shapes having predetermined curvature as shown in FIG. 7A, or cut-away portions as shown in FIG. 7B. As a result, the openings are enlarged, such that fluid is sucked smoothly. If these openings 111 and 112 are formed adjacent to a center of the first valve 110, a probability of interference between the roller 22 and the eccentric portion 13a becomes increasing. In addition, there is the fluid's probability of leaking out along the driving shaft 13, since the openings 111 and 112 communicate with a space between the roller 22 and the eccentric portion 13a. For these reasons, as shown in FIG. 7C, it is preferable that the openings 111 and 112 are positioned in the vicinity of the outer circumference of the first valve. Meanwhile, the first opening 111 may open each of the first and second suction ports 27a and 27b at each rotational direction by adjusting the rotation angle of the first valve 110. In other words, when the driving shaft 13 rotates in any one of the clockwise and counterclockwise directions, the first opening 111 communicates with the first suction port 27a while closing the second suction port 27b. When the driving shaft 13 rotates in the other of the clockwise and counterclockwise directions, the first opening 111 communicates with the second suction port 27b while closing the first suction port 27a. It is desirable to control the suction ports using such a single opening 111, since the structure of the first valve 110 is simplified much more.

Referring to FIGS. 2, 3 and 6, the second valve 120 is fixed between the cylinder 21 and the lower bearing 25 so as to guide a rotary motion of the first valve 110. The second valve 120 is a ring-shaped member having a site portion 121 which receives rotatably the first valve 110. The second valve 120 further includes a coupling hole 120a through which it is coupled with the cylinder 21 and the upper and lower bearings 24 and 25 by a coupling member. Preferably, the second valve 120 has the same thickness as the first valve 110 in order for a prevention of fluid leakage and a stable support. In addition, since the first valve 110 is partially supported by the cylinder 21, the first valve 110 may have a thickness slightly smaller than the second valve 120 in order to form a gap for the smooth rotation of the second valve 120.

Meanwhile, referring to FIG. 4, in the case of the clockwise rotation, the fluid's suction or discharge between the vane 23 and the roller 22 does not occur while the roller 22 revolves from the vane 23 to the second suction port 27b. Accordingly, a region V becomes a vacuum state. The vacuum region V causes a power loss of the driving shaft 13 and a loud noise. Accordingly, in order to overcome the problem in the vacuum region V, a third suction port 27c is provided at the lower bearing 25. The third suction port 27c is formed between the second suction port 27b and the vane 23, supplying fluid to the space between the roller 22 and the vane 23 so as not to form the vacuum state before the roller 22 passes through the second suction port 27b. Preferably, the third suction port 27c is formed in the vicinity of the vane 23 so as to remove quickly the vacuum state. However, the third suction port 27c is positioned to face the first suction port 27a since the third suction port 27c operates at a different rotational direction from the first suction port 27a. In reality, the third suction port 27c is positioned spaced by an angle (θ3) of approximately 10° from the vane 23 clockwise or counterclockwise. In addition, as shown in FIGS. 5A and 5B, the third suction port 27c can be circular shapes or curved rectangular shapes.

Since the aforementioned third suction port 27c operates along with the second suction port 27b, the suction ports 27b and 27c should be simultaneously opened while the roller 22 revolves in any one of the clockwise and counterclockwise directions. Accordingly, the first valve 110 further includes a third opening configured to communicate with the third suction port 27c at the same time when the second suction port 27b is opened. According to the present invention, the third opening 113 can be formed independently, which is represented with a dotted line in FIG. 6A. However, since the first and third suction ports 27a and 27c are adjacent to each other, it is desirable to open both the first and third suction ports 27a and 27c according to the rotational direction of the first opening 111 by increasing the rotation angle of the first valve 110.

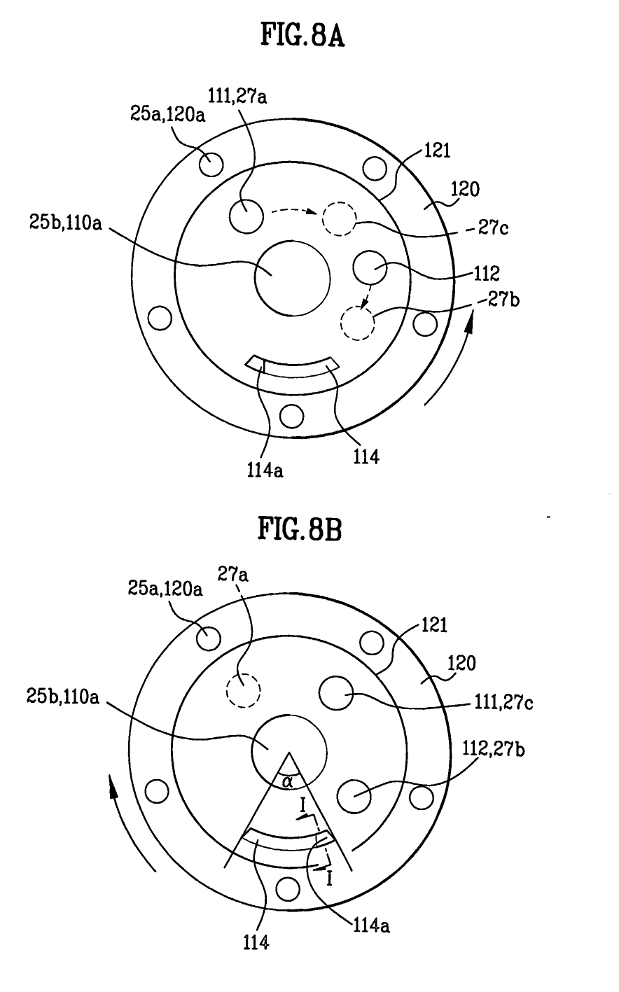

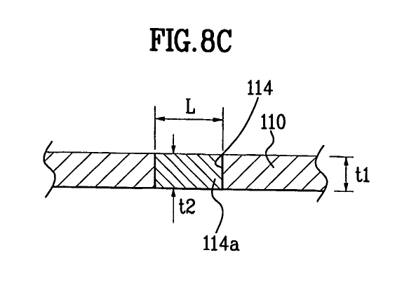

The first valve 110 may open the suction ports 27a, 27b and 27c according to the rotational direction of the roller 22, but the corresponding suction ports should be opened accurately in order to obtain desired compression capacity. The accurate opening of the suction ports can be achieved by controlling the rotation angle of the first valve. Thus, preferably, the valve assembly 100 further includes means for controlling the rotation angle of the first valve 110, which will be described in detail with reference to FIGS. 8 to 11. FIGS. 8 to 11 illustrate the valve assembly connected with the lower bearing 25 in order to clearly explain the control means.

As shown in FIGS. 8A and 8B, the control means includes a groove 114 formed at the first valve and having a predetermined length, and a stopper 114a formed on the lower bearing 25 and inserted into the groove 114. The groove 114 and the stopper 114a are illustrated in FIGS. 5A, 5B and 6. The groove 114 serves as locus of the stopper 114a and can be a straight groove or a curved groove. If the groove 114 is exposed to the chamber 29 during operation, it becomes a dead volume causing a re-expansion of fluid. Accordingly, it is desirable to make the groove 114 adjacent to a center of the first valve 110 so that large portion of the groove 114 can be covered by the revolving roller 22. Preferably, an angle (a) between both ends of the groove 114 is of 30-120° in the center of the first valve 110. In addition, if the stopper 114a is protruded from the groove 114, it is interfered with the roller 22. Accordingly, it is desirable that a thickness T2 of the stopper 114a is equal to a thickness T1 of the valve 110, as shown in FIG. 8C. Preferably, width L of the stopper 114a is equal to a width of the groove 114 such that the first valve 110 rotates stably.

In case of using the control means, the first valve 110 rotates counterclockwise together with the eccentric portion 13a of the driving shaft when the driving shaft 13 rotates counterclockwise. As shown in FIG. 8A, the stopper 114a is then latched to one end of the groove 114 to thereby stop the first valve 10. At this time, the first opening 111 accurately communicates with the first suction port 27a, and the second and third suction ports 27b and 27c are closed. As a result, fluid is introduced into the cylinder through the first suction port 27a and the first opening 111, which communicate with each other. On the contrary, if the driving shaft 13 rotates clockwise, the first valve 110 also rotates clockwise. At the same time, the first and second openings 111 and 112 also rotate clockwise, as represented with a dotted arrow in FIG. 8A. As shown in FIG. 8B, if the stopper 114a is latched to the other end of the groove 114, the first and second openings 111 and 112 are opened together with the third and second suction ports 27c and 27b. Then, the first suction port 27a is closed by the first valve 110. Accordingly, fluid is introduced through the second suction port 27b/the second opening 112 and the third suction port 27c/the first opening 111, which communicate with each other.

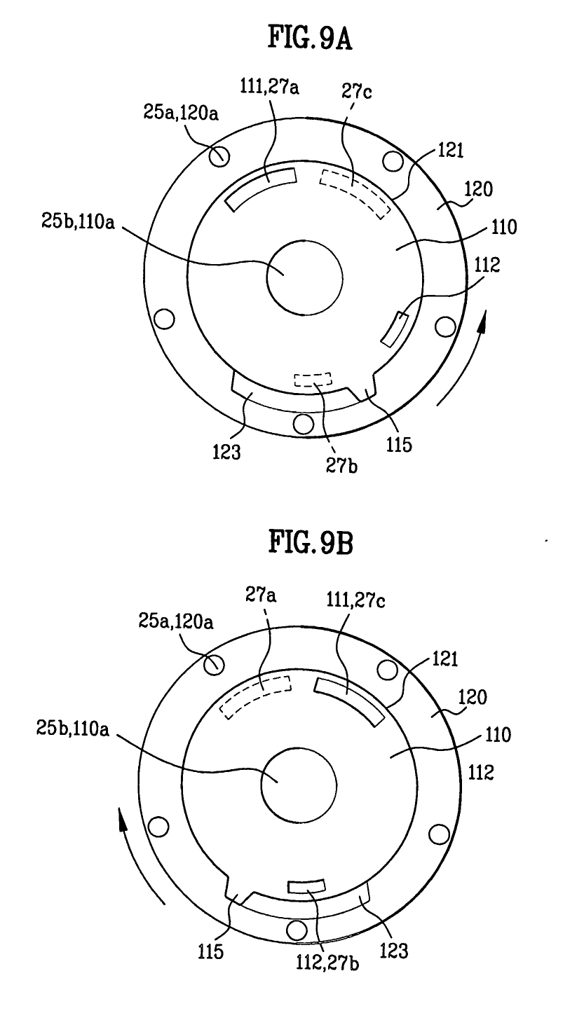

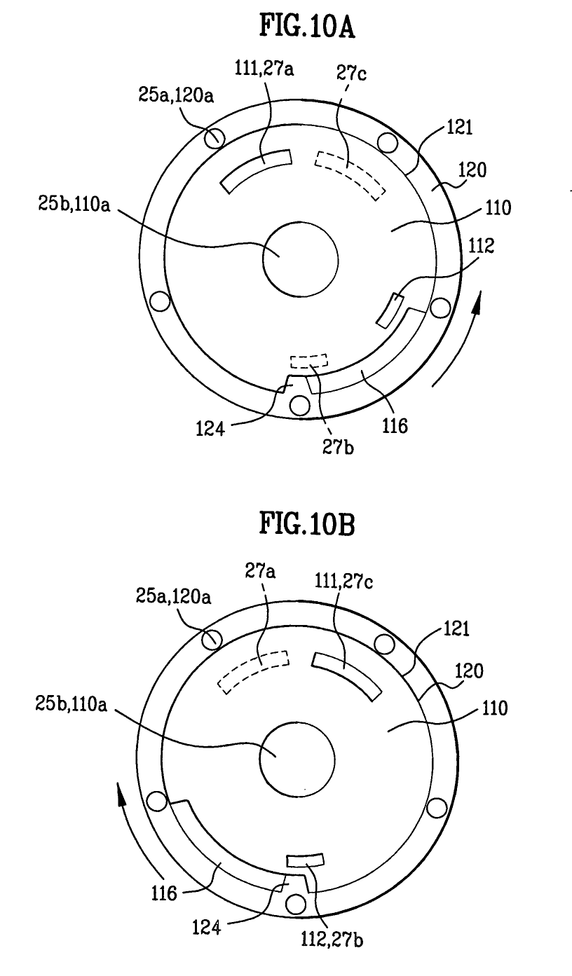

As shown in FIGS. 9A and 9B, the control means can be provided with a projection 115 formed on the first valve 110 and projecting in a radial direction of the first valve, and a groove 123 formed on the second valve 220 and receiving the projection movably. Here, the groove 123 is formed on the second valve 220 so that it is not exposed to the inner volume of the cylinder 21. Therefore, a dead volume is not formed inside the cylinder. In addition, as shown in FIGS. 10A and 10B, the control means can be provided with a projection 124 formed on the second valve 120 and projecting in a radial direction of the second valve 120, and a groove 116 formed on the first valve 110 and receiving the projection 124 movably.

In case of using such control means, the projections 115 and 124 are latched to one end of each groove 123 and 116 as shown in FIGS. 9A and 10A if the driving shaft 13 rotates counterclockwise. Accordingly, the first opening 111 communicates with the first suction port 27a so as to allow the suction of fluid, and the second and third suction ports 27b and 27c are closed. On the contrary, as shown in FIGS. 9B and 10B, if the driving shaft 13 rotates clockwise, the projections 115 and 124 are latched to the other end of each groove 123 and 116, and the first and second openings 111 and 112 simultaneously open the third and second suction ports 27c and 27b so as to allow the suction of fluid. The first suction port 27a is closed by the first valve 110.

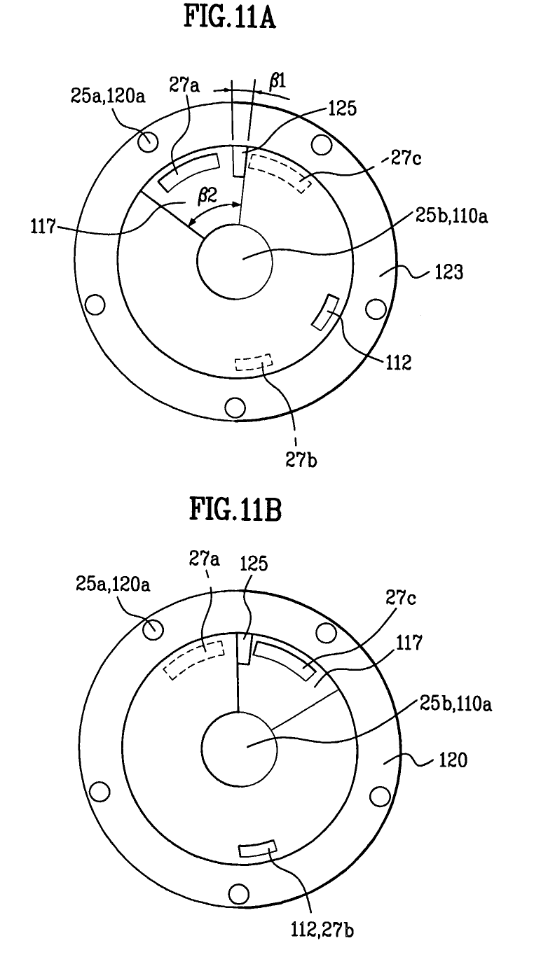

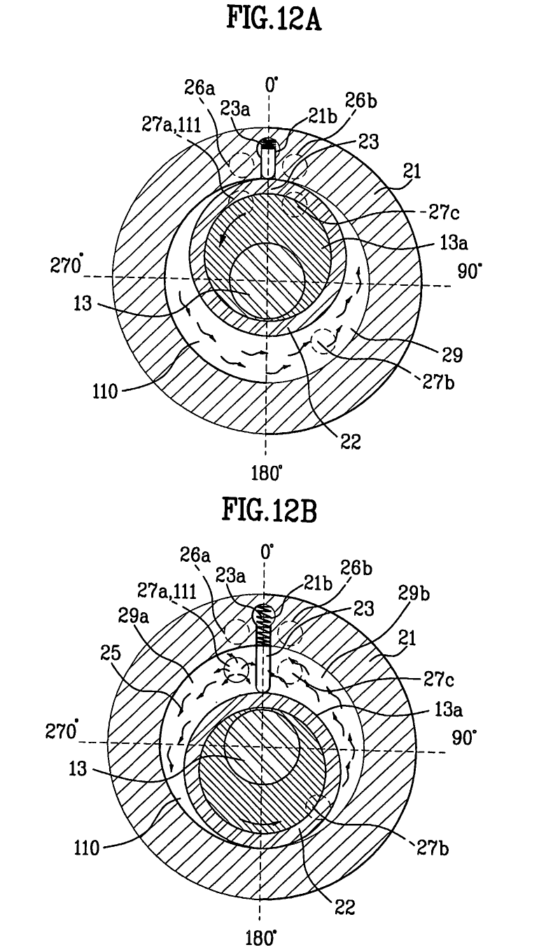

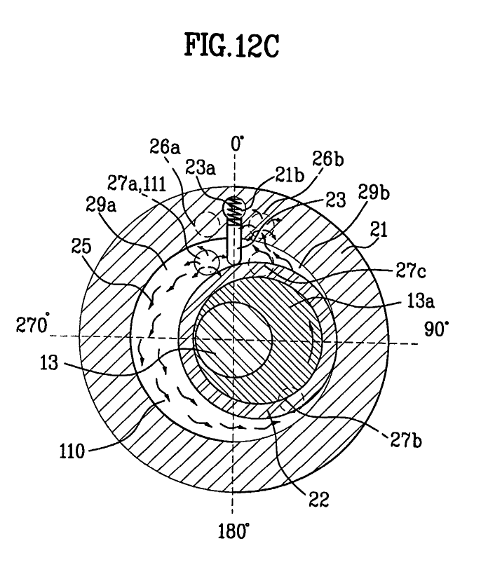

In addition, as shown in FIGS. 11A and 12B, the control means can be provided with a projection 125 formed on the second valve 120 and projecting toward a center of the second valve 120, and a cut-away portion 117 formed on the first valve 110 and movably accommodating the projection 125. In such control means, a clearance between the projection 125 and the cut-away portion 117 allows the first and second suction ports 27a and 27b to be opened by forming the cut-away portion 117 largely in a properly large size. Accordingly, the control means decreases the dead volume substantially since the grooves of the above-described control means are omitted.

In more detail, if the driving shaft 13 rotates counterclockwise, one end of the projection 125 contacts one end of the cut-away portion 17 as shown in FIG. 11A. Accordingly, a clearance between the other ends of the projection 125 and the cut-away portion 117 allows the first suction port 27a to be opened. In addition, as shown in FIG. 11B, if the driving shaft 13 rotates clockwise, the projection 125 is latched to the cut-away portion 117. At this time, the second opening 112 opens the second suction port 27b, and simultaneously, the clearance between the projection 125 and the cut-away portion 117 allows the third suction port 27c to be opened as described above. In such control means, the projection 125 preferably has an angle β1 of approximately 10° between both ends thereof and the cut-away portion 117 has an angle β2 of 30-120° between both ends thereof.

Meanwhile, as described above with reference to FIGS. 2 and 3, the suction ports 27a, 27b and 27c are individually connected with a plurality of suction pipes 7a so as to supply fluid to the fluid chamber 29 installed inside the cylinder 21. However, the number of parts increases due to these suction pipes 7a, thus making the structure complicated. In addition, fluid may not be properly supplied to the cylinder 21 due to a change in a compression state of the suction pipes 7b separated during operation. Accordingly, as expressed by a dotted line on FIG. 2, it is desirable that the compressor includes a suction plenum 500 for preliminarily storing fluid to be sucked by the compressor. Such the suction plenum 500 forms a space in which a predetermined amount of fluid is always stored, so that a pressure variation of the sucked fluid is buffered to stably supply the fluid to the suction ports 27a, 27b and 27c. In addition, the suction plenum 500 can accommodate oil extracted from the stored fluid and thus assist or substitute for the accumulator 8.

Hereinafter, operation of a rotary compressor according to a first embodiment of the present invention will be described in more detail.

FIGS. 12A to 12C are cross-sectional views sequentially illustrating insides of the cylinder when the roller revolves in the counterclockwise direction in the rotary compressors according to a first embodiment of the present invention.

First, in FIG. 12A, there are shown states of respective elements inside the cylinder when the driving shaft 13 rotates in the counterclockwise direction. First, the first suction port 27a communicates with the first opening 111, and the remainder second suction port 27b and third suction port 27c are closed. Detailed description on the state of the suction ports in the counterclockwise direction will be omitted since it has been described with reference to FIGS. 8A, 9A, 10A and 11A.

In a state that the first suction port 27a is opened, the roller 22 revolves counterclockwise with performing a rolling motion along the inner circumference of the cylinder 21 due to the rotation of the driving shaft 13. As the roller 22 continues to revolve, the size of the space 29b is reduced as shown in FIG. 12B and thus the fluid that has been sucked is compressed. In this stroke, the vane 23 moves up and down elastically by the elastic member 23a to thereby hermetically partition the fluid chamber 29 into the two sealed spaces 29a and 29b. At the same time, new fluid continues to be sucked into the space 29a through the first suction port 27a (first opening 111) so as to be compressed in a next stroke.

When the fluid pressure in the space 29b is above a predetermined value, the second discharge valve 26d shown in FIG. 2 is opened. Accordingly, as shown in FIG. 12C, the fluid is discharged through the second discharge port 26b. As the roller 22 continues to revolve, all the fluid in the space 29b is discharged through the second discharge port 26b. After the fluid is completely discharged, the second discharge valve 26d closes the second discharge port 26c by its self-elasticity.

Thus, after a single stroke is ended, the roller 22 continues to revolve counterclockwise and discharges the fluid by repeating the same stroke. In the counterclockwise stroke, the roller 22 compresses the fluid with revolving from the first suction port 27a to the second discharge port 26b. As aforementioned, since the first suction port 27a (the first opening 111) and the second discharge port 27b are positioned in the vicinity of the vane 23 to face each other, the fluid is compressed using the overall volume of the fluid chamber 29 in the counterclockwise stroke. In other words, a compressive space corresponding to the entire volume of the fluid chamber 29 is created during the counterclockwise stroke, so that a maximal compression capacity is obtained.

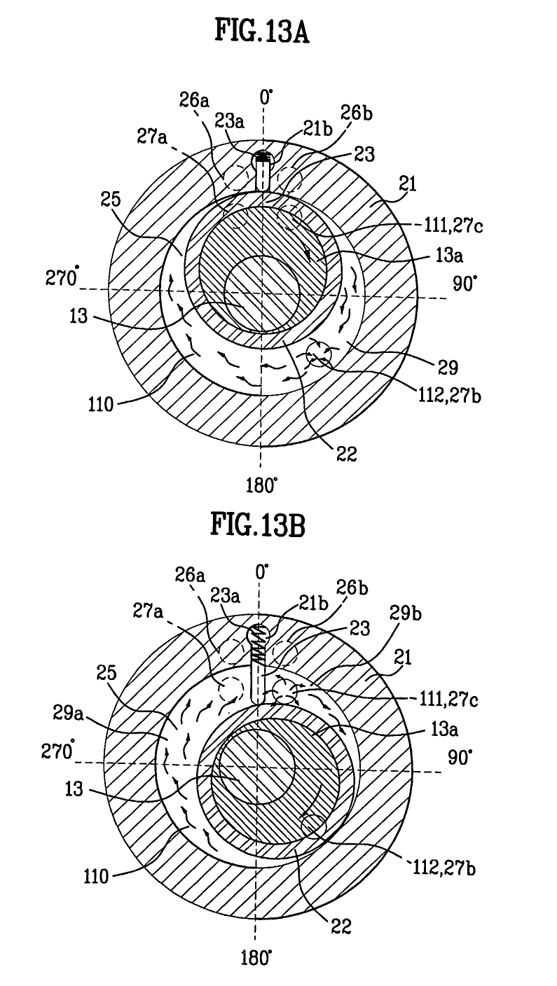

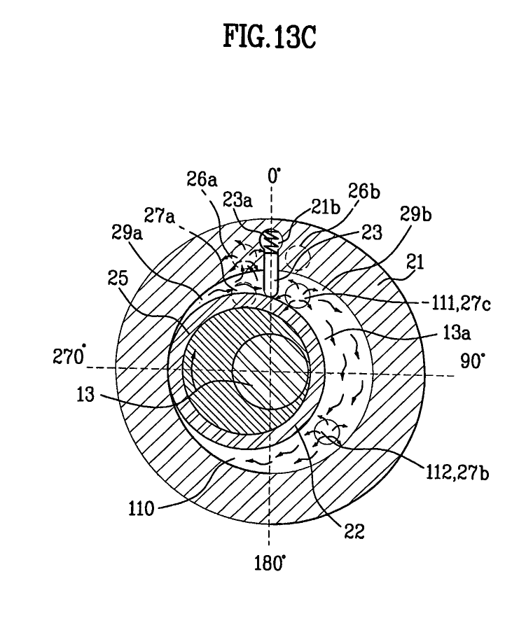

FIGS. 13A to 13C are cross-sectional views sequentially illustrating insides of the cylinder when the roller revolves in the clockwise direction in the rotary compressors according to a first embodiment of the present invention.

First, in FIG. 13A, there are shown states of respective elements inside the cylinder when the driving shaft 13 rotates in the clockwise direction. The first suction port 27a is closed, and the second suction port 27b and third suction port 27c communicate with the second opening 112 and the first opening 111 respectively. If the first valve 110 has the third opening 113 additionally (refer to FIG. 6), the third suction port 27c communicates with the third opening 113. Detailed description on the state of the suction ports in the clockwise direction will be omitted since it has been described with reference to FIGS. 8B, 9B, 10B and 11B.

In a state that the second and third suction ports 27b and 27c are opened (i.e., a state that the first and second openings 111 and 112 communicate), the roller 22 begins to revolve clockwise with performing a rolling motion along the inner circumference of the cylinder due to the clockwise rotation of the driving shaft 13. In such an initial stage revolution, the fluid sucked until the roller 22 reaches the second suction port 27b is not compressed but is forcibly exhausted outside the cylinder 21 by the roller 22 through the second suction port 27b as shown in FIG. 13A. Accordingly, the fluid begins to be compressed after the roller 22 passes the second suction port 27b as shown in FIG. 13B. At the same time, a space between the second suction port 27b and the vane 23, i.e., the space 29b is made in a vacuum state. However, as aforementioned, as the revolution of the roller 22 starts, the third suction port 27c communicates with the first opening 111 (or third opening 113) so as to suck the fluid and thus is opened. Accordingly, the vacuum state is eliminated by the sucked fluid and thus occurrence of noise and loss of power are suppressed.

As the roller 22 continues to revolve, the size of the space 29a is reduced and the fluid that has been sucked is compressed. In this compression stroke, the vane 23 moves up and down elastically by the elastic member 23a to thereby partition the fluid chamber 29 into the two sealed spaces 29a and 29b. Also, new fluid is continuously sucked into the space 29b through the second and third suction ports 27b and 27c (first and second openings 111 and 112) so as to be compressed in a next stroke.

When the fluid pressure in the space 29a is above a predetermined value, the first discharge valve 26c (see FIG. 2) is opened as shown in FIG. 13C and accordingly the fluid is discharged through the first discharge port 26a. After the fluid is completely discharged, the first discharge valve 26c closes the first discharge port 26a by its self-elasticity.

Thus, after a single stroke is ended, the roller 22 continues to revolve clockwise and discharges the fluid by repeating the same stroke. In the counterclockwise stroke, the roller 22 compresses the fluid with revolving from the second suction port 27b to the first discharge port 26a. Accordingly, the fluid is compressed using a part of the overall fluid chamber 29 in the clockwise stroke, so that a compression space that is different in size than that in the counterclockwise stroke is obtained. In more detail, a compression space smaller than that in the counterclockwise stroke is formed and thus a compression capacity smaller than that in the counterclockwise stroke is obtained.

In each of the aforementioned strokes (i.e., the clockwise stroke and the counterclockwise stroke), the discharged compressive fluid moves upward through the space between the rotor 12 and the stator 11 inside the case 1 and the space between the stator 11 and the case 1. Finally, the compressed fluid is discharged through the discharge pipe 9 out of the compressor.

In the above first embodiment, the inventive rotary compressor has suction and discharge ports properly arranged, and valve assembly having the simple structure and for selectively opening the suction ports according to the rotational direction of the driving shaft. Accordingly, although the driving shaft rotates in any one of the counterclockwise direction and clockwise direction, the fluid can be compressed. Also, different sizes of compression spaces are formed depending on the rotational direction of the driving shaft such that different compression capacities are obtained in its operation. In particular, any one of the compression capacities is formed using the predesigned entire fluid chamber.

### Second Embodiment

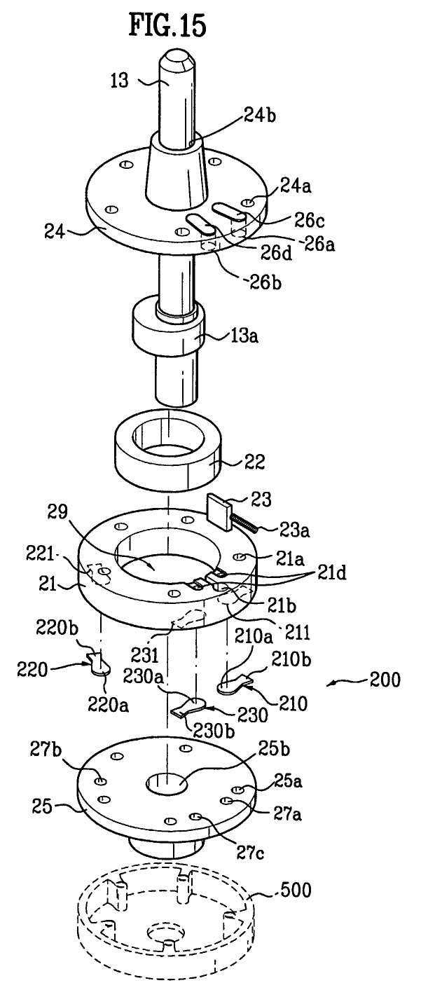

FIG. 15 is an exploded perspective view illustrating the compression unit of the rotary compressor according to a second embodiment of the present invention and

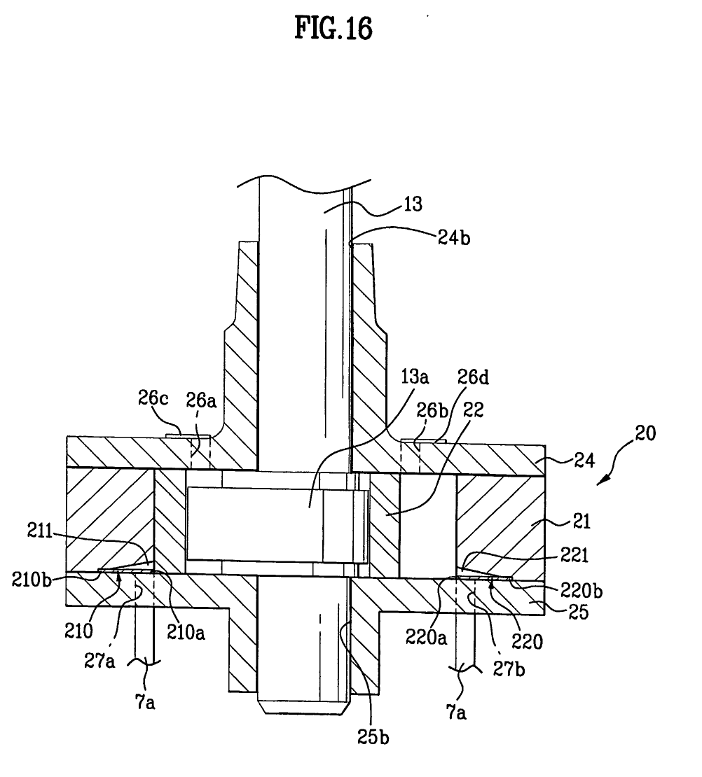

FIG. 16 is a sectional view illustrating the compressing unit according to a second embodiment of the present invention.

In the compression unit 20 of the second embodiment, the cylinder 21 has a predetermined inner volume and a strength enough to endure the pressure of the fluid to be compressed. The cylinder 21 accommodates an eccentric portion 13a formed on the driving shaft 13 in the inner volume. The eccentric portion 13a is a kind of an eccentric cam and has a center spaced by a predetermined distance from its rotation center. The cylinder 21 has a groove 21b extending by a predetermined depth from its inner circumference. A vane 23 to be described below is installed in the groove 21b. The groove 21b is long enough to accommodate the vane 23 completely.

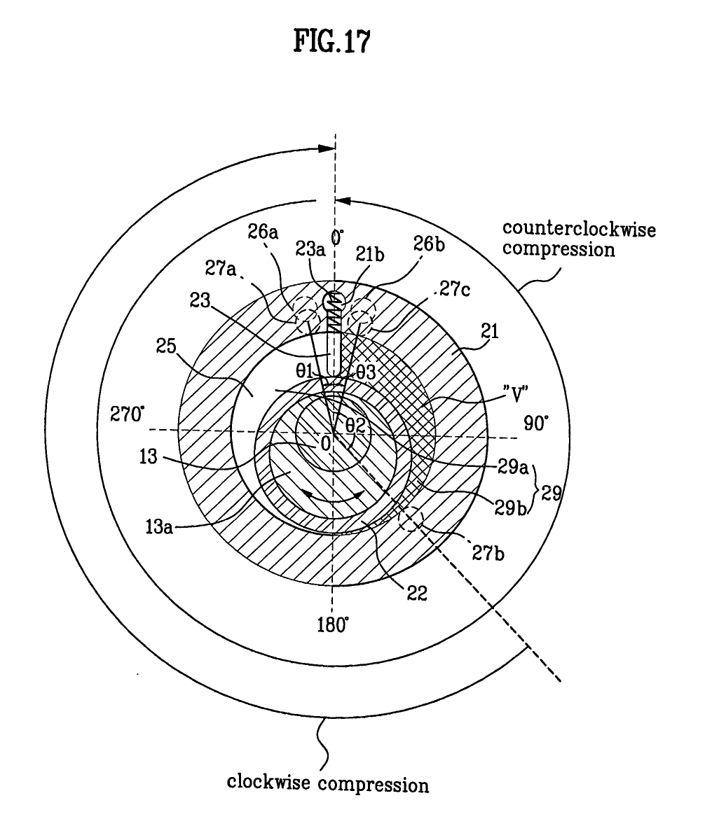

The roller 22 is a ring member that has an outer diameter less than the inner diameter of the cylinder 21. As shown in FIG. 17, the roller 22 contacts the inner circumference of the cylinder 21 and rotatably coupled with the eccentric portion 13a. Accordingly, the roller 22 performs rolling motion on the inner circumference of the cylinder 21 while spinning on the outer circumference of the eccentric portion 13a when the driving shaft 13 rotates. The roller 22 revolves spaced apart by a predetermined distance from the rotation center ‘0’ due to the eccentric portion 13a while performing the rolling motion. Since the outer circumference of the roller 22 always contacts the inner circumference due to the eccentric portion 13a, the outer circumference of the roller 22 and the inner circumference of the cylinder form a separate fluid chamber 29 in the inner volume. The fluid chamber 29 is used to suck and compress the fluid in the rotary compressor.

The vane 23 is installed in the groove 21b of the cylinder 21 as described above. An elastic member 23a is installed in the groove 21b to elastically support the vane 23. The vane 23 continuously contacts the roller 22. In other words, the elastic member 23a has one end fixed to the cylinder 21 and the other end coupled with the vane 23, and pushes the vane 23 to the side of the roller 22. Accordingly, the vane 23 divides the fluid chamber 29 into two separate spaces 29a and 29b as shown in FIG. 17. While the driving shaft 13 rotate or the roller 22 revolves, the volumes of the spaces 29a and 29b are changed complementarily. In other words, if the roller 22 rotates clockwise, the space 29a gets smaller but the other space 29b gets larger. However, the total volume of the spaces 29a and 29b is constant and approximately same as that of the predetermined fluid chamber 29. One of the spaces 29a and 29b works as a suction chamber for sucking the fluid and the other one works as a compression chamber for compressing the fluid relatively when the driving shaft 13 rotates in one direction (clockwise or counterclockwise). Accordingly, as described above, the compression chamber of the spaces 29a and 29b gets smaller to compress the previously sucked fluid and the suction chamber expands to suck the new fluid relatively according to the rotation of the roller 22. If the rotational direction of the roller 22 is reversed, the functions of the spaces 29a and 29b are exchanged. In the other words, if the roller 22 revolves counterclockwise, the right space 29b of the roller 22 becomes a compression chamber, but if the roller 22 revolves clockwise, the left space 29a of the roller 22 becomes a discharge unit.

The upper bearing 24 and the lower bearing 25 are, as shown in FIG. 15, installed on the upper and lower portions of the cylinder 21 respectively, and rotatably support the driving shaft 12 using a sleeve and the penetrating holes 24b and 25b formed inside the sleeve. In more detail, the upper bearing 24, the lower bearing 25 and the cylinder 21 include a plurality of coupling holes 24a, 25a and 21a formed to correspond to each other respectively. The cylinder 21, the upper bearing 24 and the lower bearing 25 are coupled with one another to seal the cylinder inner volume, especially the fluid chamber 29 using coupling members such as bolts and nuts.

Referring to FIGS. 15 and 16, discharge ports 26a and 26b are formed on the upper bearing 24. The discharge ports 26a and 26b communicate with the fluid chamber 29 so that the compressed fluid can be discharged. The discharge ports 26a and 26b can communicate directly with the fluid chamber 29 or can communicate with the fluid chamber 29 through a predetermined fluid passage 21d formed in the cylinder 21 and the upper bearing 24. As shown in the drawings, the discharge ports 26a and 26b are formed on the upper bearing 24, but if necessary, it may be formed on the lower bearing 25. Also, the discharge ports 26a and 26b may be formed in the cylinder 21 so as to communicate with the inside of the cylinder 21 easily. Discharge valves 26c and 26d are installed in the upper bearing 24 so as to open and close the discharge ports 26a and 26b.

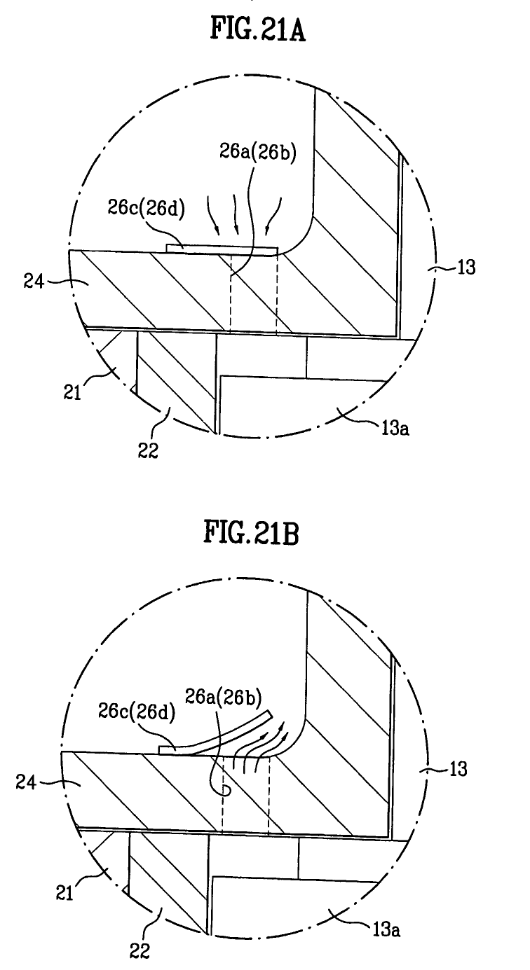

FIGS. 21A and 21B are sectional views illustrating operations of these discharge valves 26c and 26d.

The discharge valves 26c and 26d are configured to open the discharge ports 26a and 26b when a positive pressure which is greater than or equal to a predetermined pressure is generated in the inside of the cylinder 21. To achieve this, it is desirable that the discharge valves 26c and 26d are a plate valve of which one end is fixed in the vicinity of the discharge ports 26a and 26b and the other end can be deformed freely. These discharge valves 26c and 26d are deformed toward a relatively low pressure by a relatively high pressure. However, in case a relatively high pressure is generated outside the cylinder 21, the discharge valves 26c and 26d are confined by the upper bearing 24. In more detail, as shown in FIG. 21A, if a negative pressure is generated inside the cylinder 21, the discharge valves 26c and 26d are deformed toward the cylinder 21 due to the pressure (atmospheric pressure) outside the cylinder 21 that is relatively high. However, the discharge valves 26c and 26d are confined by the upper bearing 24 and are not deformed but close the discharge ports 26a and 26b more firmly on its behalf. Also, in case a relatively low positive pressure is generated in the cylinder 21, the discharge ports 26a and 26b continue to be closed by the self-elasticity of the discharge valves 26c and 26d. After that, if a positive pressure above a predetermined value, i.e., a positive pressure that is larger than the elasticity of the discharge valves 26c and 26d is generated, the discharge valves 26c and 26d are deformed so as to open the discharge ports 26a and 26b as shown in FIG. 21B. Accordingly, only when the pressure of the chamber 29 is above a predetermined positive pressure, the discharge valves 26c and 26d selectively open the discharge ports 26a and 26b. Although not shown in the drawings, a retainer for limiting the deformable amount may be installed on the upper portion of the discharge valves 26c and 26d so that the valves can operate stably. In addition, a muffler (not shown) may be installed on the upper portion of the upper bearing 24 to reduce a noise generated when the compressed fluid is discharged.

Referring to FIGS. 15 and 16, suction ports 27a, 27b and 27c communicating with the fluid chamber 29 are formed on the lower bearing 25. The suction ports 27a, 27b and 27c guide the fluid to be compressed to the fluid chamber 29. The suction ports 27a, 27b and 27c are connected to the suction pipe 7 so that the fluid outside the compressor can flow into the chamber 29. In more concrete, the suction pipe 7 is branched into a plurality of auxiliary pipes 7a and the auxiliary pipes 7a are connected to suction ports 27a and 27b respectively. If necessary, the discharge ports 26a, and 26b may be formed in the cylinder 21 so as to communicate with the inside of the cylinder 21 with ease like the aforementioned discharge ports 26a and 26b. Also, the discharge ports 26a and 26b may be formed on the lower bearing 25 and the suction ports 27a, 27b and 27c may be formed on the upper bearing 24.

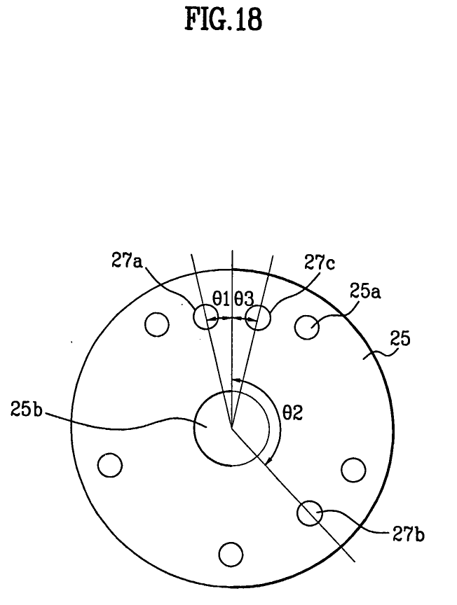

These suction and discharge ports 26 and 27 become the important factors in determining compression capacity of the rotary compressor, and will be described referring to FIGS. 17 and 18. FIG. 17 is a cross-sectional view illustrating the inside of the cylinder according to a second embodiment of the present invention.

First, the compressor of the present invention includes at least two discharge ports 26a and 26b. As shown in the drawing, even if the roller 22 revolves in any direction, a discharge port should exist between the suction port and vane 23 positioned in the revolution path to discharge the compressed fluid. Accordingly, one discharge port is necessary for each rotational direction, and allows the compressor of the present invention to discharge the fluid regardless of the revolution direction of the roller 22 (that is, the rotational direction of the driving shaft 13). Meanwhile, as described above, the compression chamber of the spaces 29a and 29b gets smaller to compress the fluid as the roller 22 approaches the vane 23. Accordingly, the discharge ports 26a and 26b are preferably formed facing each other in the vicinity of the vane 23 to discharge the maximum compressed fluid. In other word, as shown in the drawings, the discharge ports 26a and 26b are positioned on both sides of the vane 23 respectively. The discharge ports 26a and 26b are preferably positioned in the vicinity of the vane 23 if possible.

The suction port 27 is positioned properly so that the fluid can be compressed between the discharge ports 26a and 26b and the roller 22. Actually, the fluid is compressed from a suction port to a discharge port positioned in the revolution path of the roller 22. In other words, the relative position of the suction port for the corresponding discharge port determines the compression capacity and accordingly two compression capacities can be obtained using different suction ports 27 according to the rotational direction. Accordingly, the compression of the present invention has first and second suction ports 27a and 27b corresponding to two discharge ports 26a and 26b respectively and the suction ports are spaced apart by a predetermined angle from each other with respect to the center 0 for two different compression capacities.

Preferably, the first suction port 27a is positioned in the vicinity of the vane 23. Accordingly, the roller 22 compresses the fluid from the first suction port 27a to the second discharge port 26b positioned across the vane 23 in its rotation in one direction (counterclockwise in the drawing). The roller 22 compress the fluid due to the first suction port 27a by using the overall chamber 29 and accordingly the compressor has a maximum compression capacity in the counterclockwise rotation. In other words, the fluid as much as overall volume of the chamber 29 is compressed. The first suction port 27a is actually spaced apart by an angle θ1 of 10° clockwise or counterclockwise from the vane 23 as shown in FIGS. 4 and 5A. The drawings of the present invention illustrates the first suction port 27a spaced apart by the angle θ1 counterclockwise. At this separating angle θ1, the overall fluid chamber 29 can be used to compress the fluid without interference of the vane 23.

The second suction port 27b is spaced apart by a predetermined angle from the first suction port 27a with respect to the center. The roller 20 compresses the fluid from the second suction port 27b to the first discharge port 26a in its rotation in counterclockwise direction. Since the second suction port 27b is spaced apart by a considerable angle clockwise from the vane 23, the roller 22 compresses the fluid by using a portion of the chamber 29 and accordingly the compressor has the less compression capacity than that of counterclockwise rotary motion. In other words, the fluid as much as a portion volume of the chamber 29 is compressed. The second suction port 27b is preferably spaced apart by an angle θ2 of a range of 90-180° clockwise or counterclockwise from the vane 23. The second suction port 27b is preferably positioned facing the first suction port 27a so that the difference between compression capacities can be made properly and the interference can be avoid for each rotational direction.

As shown in FIG. 18, the suction ports 27a and 27b are generally in circular shapes whose diameters are, preferably, 6-15 mm. In order to increase a suction amount of fluid, the suction ports 27a and 27b can also be provided in several shapes, including a rectangle. Further, the rectangular suction ports 27a and 27b may have a predetermined curvature.

Meanwhile, in order to obtain desired compression capacity in each rotational direction, suction ports that are available in any one of rotational directions should be single. If there are two suction ports in revolution path of the roller 22, the compression does not occur between the suction ports. In other words, if the first suction port 27a is opened, the second suction port 27b should be closed, and vice versa. Accordingly, the valve assembly 200 is installed between the lower bearing 24 and the cylinder 21 to selectively open only one of the suction ports 27a and 27b according to the revolution direction (i.e., rotational direction of the driving shaft 13). Thus, by selectively opening a specific one of the suction ports, different compression spaces can be substantially formed in the fluid chamber 29 according to the rotational direction, so that the valve assembly 200 acts as the inventive compression mechanism previously defined.

As shown in FIGS. 15 and 16, the valve assembly 200 includes first and second valves 210 and 220, which are installed between the cylinder 21 and the lower bearing 25 so as to allow it to be adjacent to the suction ports. If the suction ports 27a, 27b and 27c are formed on the upper bearing 24, the first and second valves 210 and 220 are installed between the cylinder 21 and the upper bearing 24.

Basically, so as for the fluid to be sucked into the inside of the cylinder 21, i.e., into the inside of the fluid chamber 21, the inner pressure of the cylinder 21 should be lower than the outer pressure (atmospheric pressure) of the cylinder 21. Accordingly, the first and second valves 210 and 220 are configured to open the suction ports 27a and 27b when a pressure difference between the inside and the outside of the cylinder 21, more precisely, a negative pressure above a predetermined pressure is generated in the cylinder 21. To achieve this, the first and second valves 210 and 220 may be a check valve allowing one directional flow due to a pressure difference, i.e., fluid flow into the inside of the cylinder 21. In the meanwhile, the first and second valves may be a plate valve similarly with the discharge valves 26c and 26d. In the invention, the plate valve is preferable since it can perform the same function with more simple and higher response. The first and second valves 210 and 220 as the plate valves have second ends 210b and 220b fixed around the discharge ports 26a and 26b and first ends 210a and 220a that are freely deformable. The first and second valves 210 and 220 are deformable by an external pressure of the cylinder 21 that is relatively high, only when a negative pressure is generated inside the cylinder 21. On the contrary, in case a positive pressure is generated inside the cylinder 21, the first and second valves are confined by the lower bearing 25 so as not to be deformed. Also, the first and second valves 210 and 220 may be provided with a retainer for restricting deformation of the first ends 210a and 220a. In the present invention, the retainer may be an independent member but is preferably simple structured grooves 211, 221 formed in the cylinder 21. The grooves 211, 221 extend with a slope in the length direction of the valves 210 and 220, and the valves, more accurately, the first ends 210a and 220a, are received in the grooves 211 and 221 as deformed. Accordingly, the grooves 211 and 221 restrict an excessive deformation due to an abrupt pressure variation to thereby allow the valves 210 and 220 to operate stably.

In the meanwhile, referring to FIG. 17, in the case of the clockwise rotation, the fluid's suction or discharge between the vane 23 and the roller 22 does not occur while the roller 22 revolves from the vane 23 to the second suction port 27b. Accordingly, a region V becomes a vacuum state. The vacuum region V causes a power loss of the driving shaft 13 and a loud noise. Accordingly, in order to overcome the problem in the vacuum region V, a third suction port 27c is provided at the lower bearing 25. The third suction port 27c is formed between the second suction port 27b and the vane 23, supplying fluid to the space between the roller 22 and the vane 23 so as not to form the vacuum state before the roller 22 passes through the second suction port 27b. Preferably, the third suction port 27c is formed in the vicinity of the vane 23 so as to remove quickly the vacuum state. However, the third suction port 27c is positioned to face the first suction port 27a since the third suction port 27c operates at a different rotational direction from the first suction port 27a. In reality, the third suction port 27c is positioned spaced by an angle (θ3) of approximately 10° from the vane 23 clockwise or counterclockwise. Also, the third suction port 27c may be a circular shape or a curved rectangular shape like the first and second suction ports 27a and 27b.

Since the aforementioned third suction port 27c operates along with the second suction port 27b, the suction ports 27b and 27c should be simultaneously opened while the roller 22 revolves in any one of the clockwise and counterclockwise directions. Accordingly, the valve assembly 200 further includes a third valve 230 configured to open the third suction port 27c as soon as the second suction port 27b is opened. Like the first and second valves 210 and 220, the third valve 230 is configured to open the suction port 27c when a negative pressure above a predetermined pressure is generated in the cylinder 21. The third valve 230 may be a check valve or a plate valve. In case the third valve 230 is a plate valve, it has first ends 210a, 220a and second ends 210b and 220b like the first and second valves 210 and 220. Also, the third valve 230 as the plate valve may have a groove 231 as a retainer. Since characteristics of this third valve 230 are the same as those of the first and second valves 210 and 220 as described above, its detailed description will be omitted.

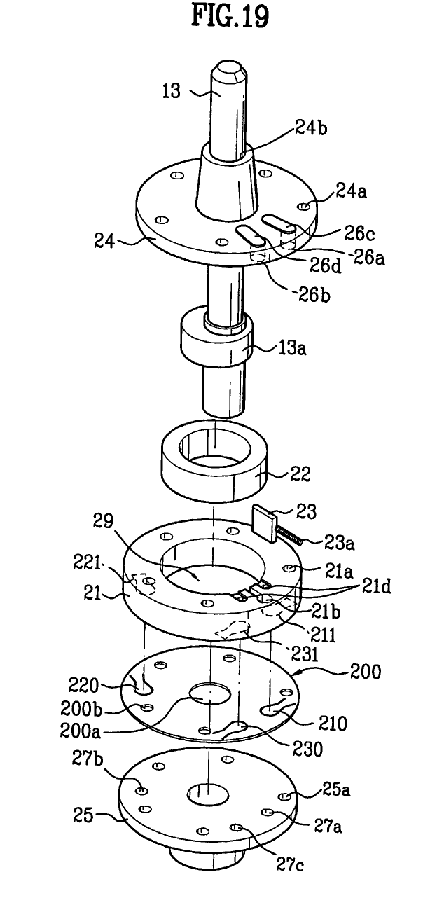

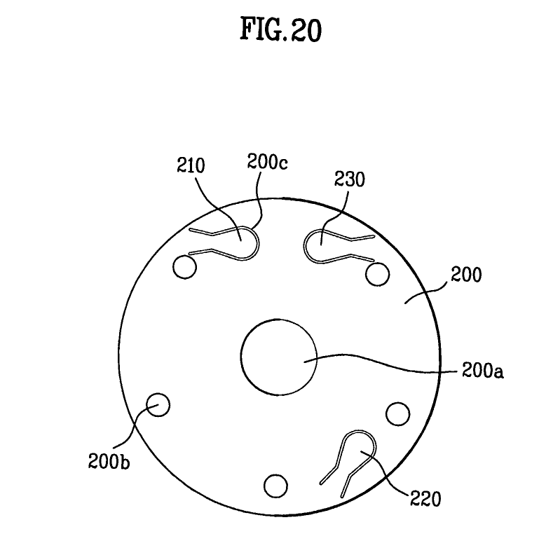

In FIGS. 15 and 16, the valve assembly is shown in divided valves 210, 220 and 230. In case the valves 210, 220 and 230 are a plate valve, the valve assembly 200 is preferably a single plate member which the plurality of valves 210, 220 and 230 are connected with one another as shown in FIGS. 19 and 20. In more detail, the valves 210, 220 and 230 of the valve assembly 200 can be easily formed by grooves 200c formed in the plate member. Also, the valve assembly 200 includes a penetration hole 200a through which the driving shaft 13 passes. Further, the valve assembly 200 has a coupling hole 200b corresponding to coupling holes 21a, 24a and 25a of the cylinder 21 and the upper and lower bearings 25 and 25, and can be coupled with the cylinder 21 and the upper and lower bearings 24 and 25 by using a proper coupling member. Since the valve assembly 200 can be assembled or fabricated with ease, it is possible to decrease production costs and enhance productivity.

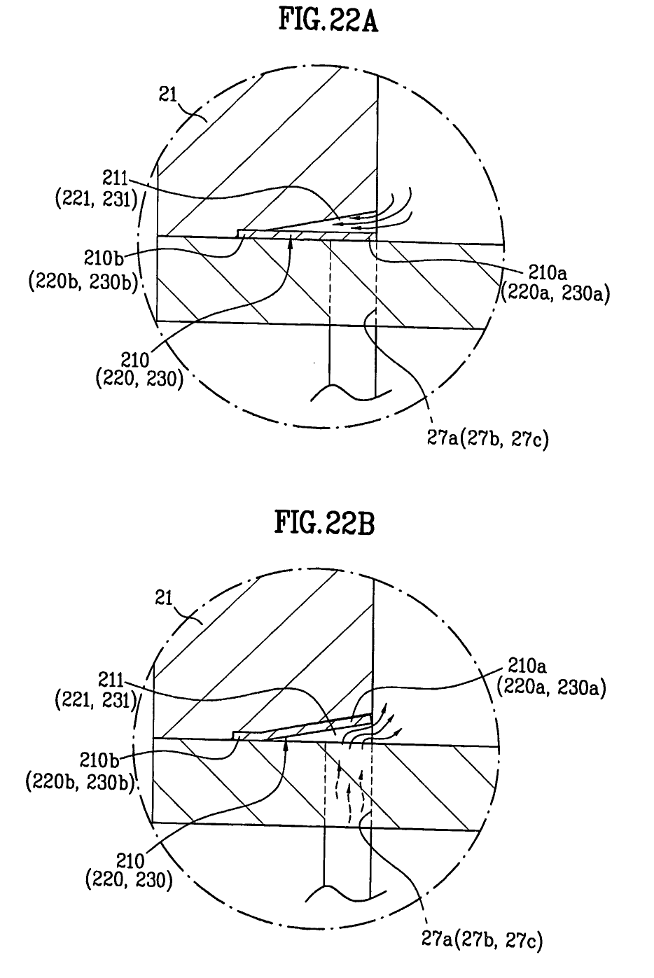

In the aforementioned valve assembly 200, as shown in FIG. 22A, if a positive pressure is generated in the chamber 29, the valves 210, 220 and 230 are deformed toward the lower bearing 25. However, the valves 210, 220 and 230 are confined by the upper bearing 24 and are not deformed, but close the suction ports 27a, 27b and 27cb more firmly on its behalf. Also, in case a relatively low negative pressure is generated in the cylinder 21, the suction ports 27a, 27b and 27c continue to be closed by the self-elasticity of the valves 210, 220 and 230. After that, if a negative pressure above a predetermined value, i.e., a negative pressure that is larger than the elasticity of the valves 210, 220 and 230 is generated, the valves 210, 220 and 230 are deformed toward the cylinder 21 as shown in FIG. 22B, so that the suction ports 27a and 27b are opened. Accordingly, the valves 210, 220 and 230 selectively open the suction ports 27a, 27b and 27c by using a pressure difference between the inside and the outside of the cylinder 21.

In more detail, as shown in FIG. 17, if the driving shaft 13 rotates any one direction (counterclockwise on the drawing), space 29b in front of the rotational direction is gradually reduced and thus the fluid is compressed. In the meanwhile, a negative pressure is formed in a space 29a formed at an opposite place to the rotational direction. Accordingly, as aforementioned, the first valve 210 opens the first suction port 27a. Likewise, if the driving shaft 13 rotates in other direction (clockwise on the drawing), a negative pressure is formed in the space 29b, and the second valve 220 opens the second suction port 27b. Like the second valve 220, the third valve 230 is influenced by the negative pressure to open the second suction port 27c in the clockwise rotation of the driving shaft 13. Resultantly, the first to third valves 210, 220 and 230 in the valve assembly 200 of the invention selectively open the corresponding suction valves 27a, 27b and 27c according to the rotational direction of the driving shaft 13.

Meanwhile, as described above with reference to FIGS. 15 and 16, the suction ports 27a, 27b and 27c are individually connected with a plurality of suction pipes 7a so as to supply fluid to the fluid chamber 29 inside the cylinder 21. However, the number of parts increases due to these suction pipes 7a, thus making the structure complicated. In addition, fluid may not be properly supplied to the cylinder 21 due to a change in a compression state of the suction pipes 7b separated during operation. Accordingly, as expressed by a dotted line on FIG. 15, it is desirable that the compressor includes a suction plenum 500 for preliminarily storing fluid to be sucked by the compressor. Such the suction plenum 500 forms a space in which a predetermined amount of fluid is always stored, so that a pressure variation of the sucked fluid is buffered to stably supply the fluid to the suction ports 27a, 27b and 27c. In addition, the suction plenum 500 can accommodate oil extracted from the stored fluid and thus assist or substitute for the accumulator 8.

Hereinafter, operation of a rotary compressor according to a second embodiment of the present invention will be described in more detail.

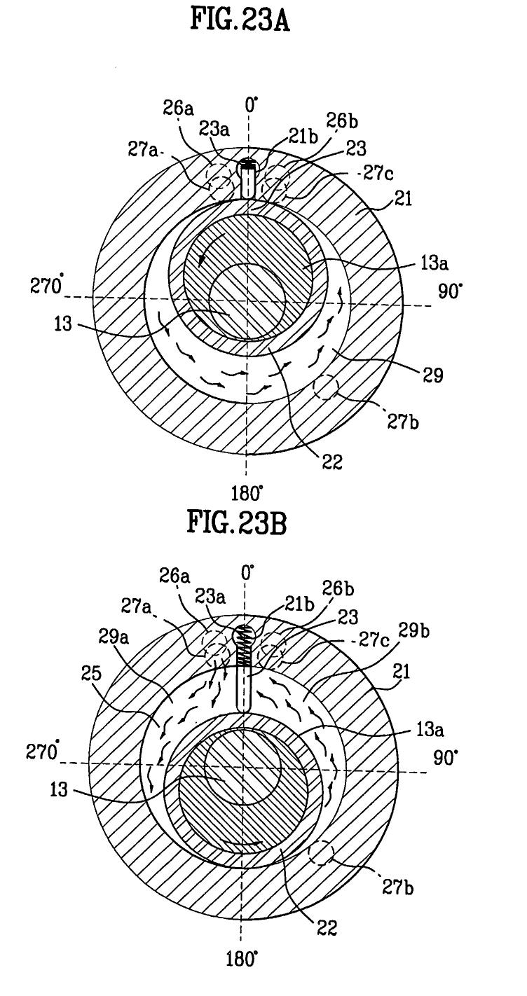

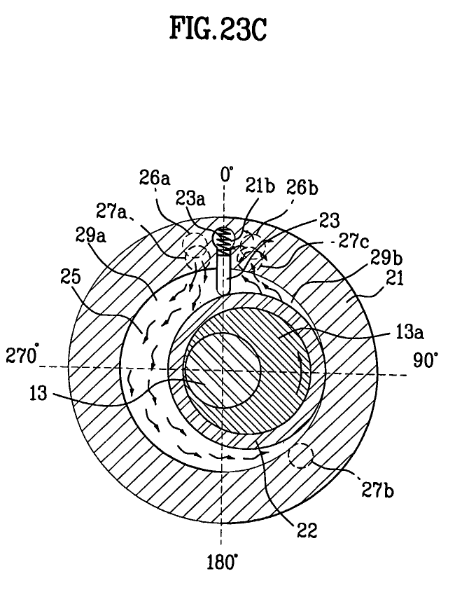

FIGS. 23A to 23C are cross-sectional views sequentially illustrating insides of the cylinder when the roller revolves in the counterclockwise direction in the rotary compressors according to a second embodiment of the present invention.

First, in FIG. 23A, there are shown states of respective elements inside the cylinder when the driving shaft 13 begins to rotate in the counterclockwise direction. Since there is no pressure variation in the cylinder 21, the suction and discharge ports are closed by the respective valves. Since operations of the respective valves in the counterclockwise rotation have been described with reference to FIGS. 21A to 22B in the above, its detailed description will be omitted.

The roller 22 revolves counterclockwise with performing a rolling motion along the inner circumference of the cylinder 21 due to the rotation of the driving shaft 13. As the roller 22 continues to revolve, the size of the space 29b is reduced as shown in FIG. 23B and thus the fluid that has been sucked is compressed. Due to the compression, a positive pressure is generated in the space 29b and accordingly the second and third suction ports 27b and 27c are more firmly closed. At the same time, as a negative pressure is generated in the space 29a, the first suction port 27a is opened and the first discharge port 26a is closed. New fluid continues to be sucked into the space 29a through the first suction port 27a so as to be compressed in a next stroke. In this stroke, the vane 23 moves up and down elastically by the elastic member 23a to thereby hermetically partition the fluid chamber 29 into the two sealed spaces 29a and 29b.

When the fluid pressure in the space 29b is above a predetermined value, the second discharge port 26b is opened and as shown in FIG. 23C, the fluid is discharged through the second discharge port 26b. As the roller 22 continues to revolve, all the fluid in the space 29b is discharged through the second discharge port 26b. After the fluid is completely discharged, the second discharge valve 26d closes the second discharge port 26c by its self-elasticity.

Thus, after a single stroke is ended, the roller 22 continues to revolve counterclockwise and discharges the fluid by repeating the same stroke. In the counterclockwise stroke, the roller 22 compresses the fluid with revolving from the first suction port 27a to the second discharge port 26b. As aforementioned, since the first suction port 27a and the second discharge port 27b are positioned in the vicinity of the vane 23 to face each other, the fluid is compressed using the overall volume of the fluid chamber 29 in the counterclockwise stroke and thus a maximal compression capacity is obtained.

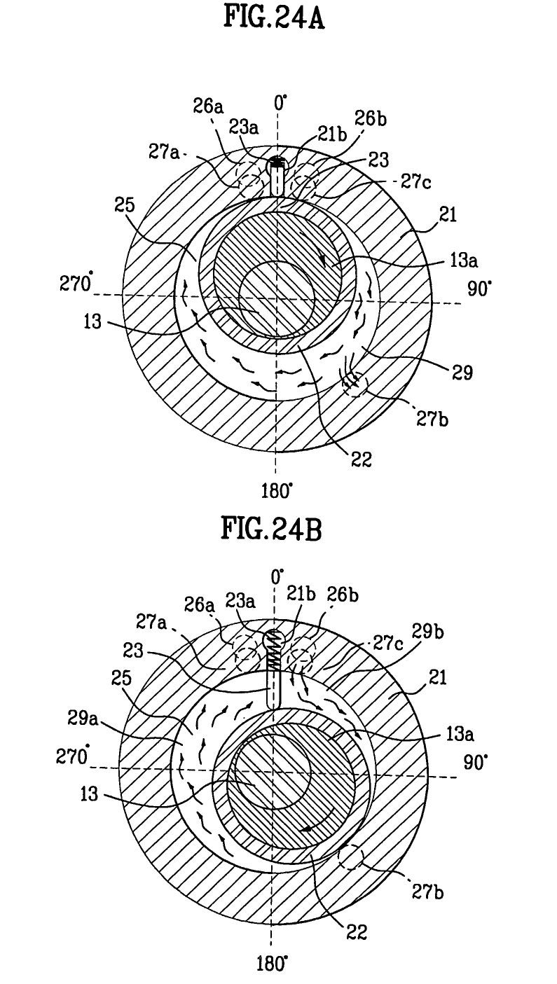

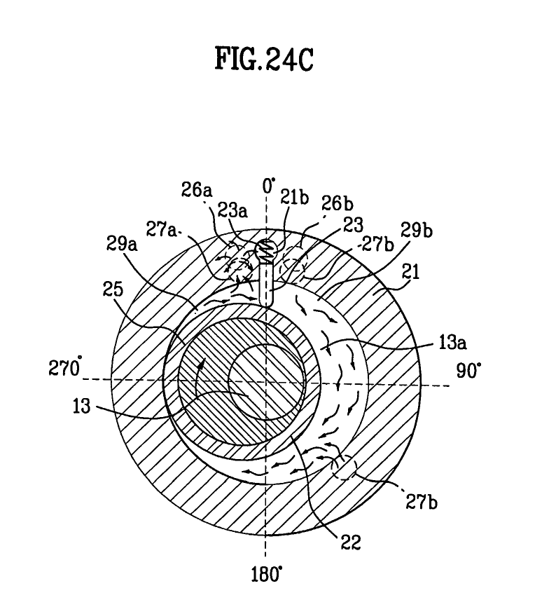

FIGS. 24A to 24C are cross-sectional views sequentially illustrating insides of the cylinder when the roller revolves in the clockwise direction in the rotary compressors according to a second embodiment of the present invention.

First, in FIG. 24A, there are shown states of respective elements inside the cylinder when the driving shaft 13 rotates in the clockwise direction. Since there is no pressure variation in the cylinder 21, the suction and discharge ports are closed by the respective valves as aforementioned. Since operations of the respective valves in the counterclockwise rotation have been described with reference to FIGS. 21A to 22B in the above, its detailed description will be omitted.

The roller 22 begins to revolve clockwise with performing a rolling motion along the inner circumference of the cylinder 21 due to the rotation of the driving shaft 13. In such an initial stage revolution, the fluid sucked until the roller 22 reaches the second suction port 27b is not compressed but is forcibly exhausted outside the cylinder 21 by the roller 22 through the second suction port 27b as shown in FIG. 24A. For this purpose, it is preferable that a predetermined clearance is always formed between the second valve 220 and the lower bearing 25. Before a relatively large positive pressure is applied, the fluid is leaked to the outside through the clearance and the second suction port 27b. If a large positive pressure is generated, the second valve 220 closes the second suction port 27b firmly such that the compressed fluid is not leaked. Accordingly, the fluid begins to be compressed as shown in FIG. 24B after the roller 22 passes through the second suction port 27b. At the same time, a space 29b between the suction port 27b and the vane 23 becomes a negative pressure state, the second discharge port 26b is closed but the third suction port 27c is opened. Accordingly, the vacuum state in the space 29b is eliminated by the sucked fluid and thus occurrence of noise and loss of power are suppressed. Also, the space 29a is in a relatively positive pressure state and the first suction port 27a is closed such that the compressed fluid is not leaked.

As the roller 22 continues to revolve, the size of the space 29a is reduced and the fluid that has been sucked is further compressed. In this compression stroke, the vane 23 moves up and down elastically by the elastic member 23a to thereby partition the fluid chamber 29 into the two sealed spaces 29a and 29b. Also, while the negative pressure state of the space 29b is held, the second suction port 27c as well as the third suction port 27c is opened, so that new fluid is continuously sucked into the space 29b so as to be compressed in a next stroke.

When the fluid pressure in the space 29a is above a predetermined value, the first discharge port 26a is opened as shown in FIG. 24C and accordingly the fluid is discharged through the first discharge port 26a. After the fluid is completely discharged, the first discharge valve 26c closes the first discharge port 26a by its self-elasticity.

Thus, after a single stroke is ended, the roller 22 continues to revolve clockwise and discharges the fluid by repeating the same stroke. In the counterclockwise stroke, the roller 22 compresses the fluid with revolving from the second suction port 27b to the first discharge port 26a. Accordingly, the fluid is compressed using a part of the overall fluid chamber 29 in the counterclockwise stroke, so that a compression capacity that is smaller than that in the clockwise direction is obtained.

In the aforementioned strokes (i.e., the clockwise stroke and the counterclockwise stroke), the discharged compressive fluid moves upward through the space between the rotor 12 and the stator 11 inside the case 1 and the space between the stator 11 and the case 1. Finally, the compressed fluid is discharged through the discharge pipe 9 out of the compressor.

In the aforementioned second embodiment, the inventive rotary compressor has suction and discharge ports properly arranged, and valve assembly having the simple structure and for selectively opening the suction ports according to the rotational direction of the driving shaft. Accordingly, although the driving shaft rotates in any one of the counterclockwise direction and clockwise direction, the fluid can be compressed. Also, different sizes of compression spaces are formed depending on the rotational direction of the driving shaft such that different compression capacities are obtained in its operation. In particular, any one of the compression capacities is formed using the predesigned entire fluid chamber.

### Third Embodiment

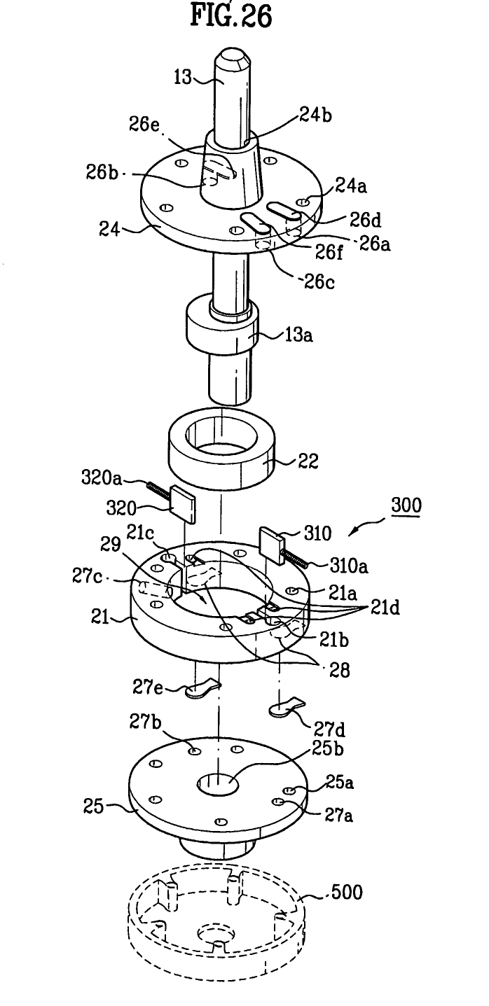

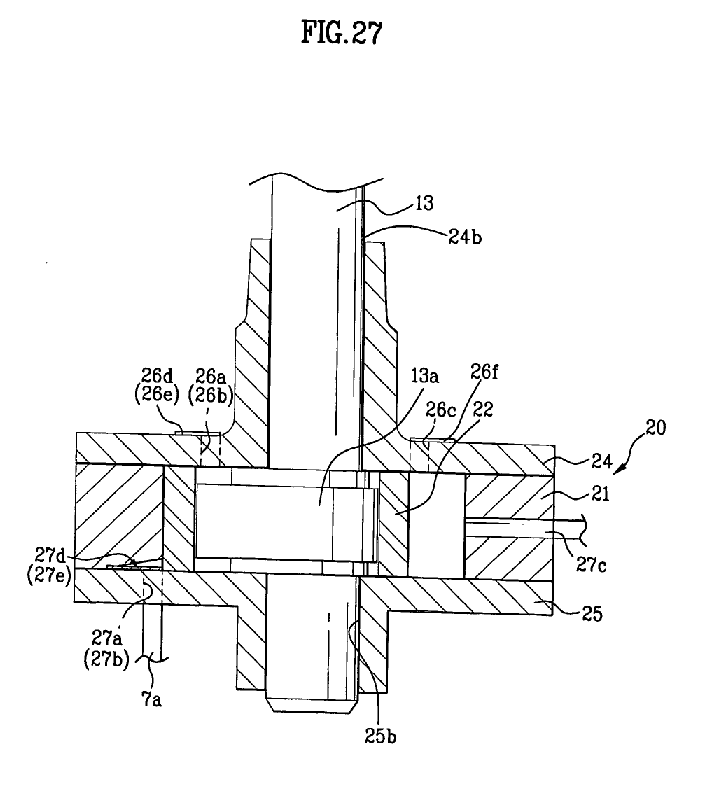

FIG. 26 is an exploded perspective view illustrating the compression unit of the rotary compressor according to a third embodiment of the present invention and FIG. 27 is a sectional view illustrating the compressing unit according to a third embodiment of the present invention.

In the third embodiment, the cylinder 21 has a predetermined inner volume and a strength enough to endure the pressure of the fluid to be compressed. The cylinder 21 accommodates an eccentric portion 13a formed on the driving shaft 13 in the inner volume. The eccentric portion 13a is a kind of an eccentric cam and has a center spaced by a predetermined distance from its rotation center. The cylinder 21 has a groove 21b extending by a predetermined depth from its inner circumference. A vane 23 to be described below is installed in the groove 21b. The groove 21b is long enough to accommodate the vane 23 completely.

The roller 22 is a ring member that has an outer diameter less than the inner diameter of the cylinder 21. As shown in FIG. 17, the roller 22 contacts the inner circumference of the cylinder 21 and rotatably coupled with the eccentric portion 13a. Accordingly, the roller 22 performs rolling motion on the inner circumference of the cylinder 21 while spinning on the outer circumference of the eccentric portion 13a when the driving shaft 13 rotates. The roller 22 revolves spaced apart by a predetermined distance from the rotation center ‘0’ due to the eccentric portion 13a while performing the rolling motion. Since the outer circumference of the roller 22 always contacts the inner circumference due to the eccentric portion 13a, the outer circumference of the roller 22 and the inner circumference of the cylinder form a separate fluid chamber 29 in the inner volume. The fluid chamber 29 is used to suck and compress the fluid in the rotary compressor.

The upper bearing 24 and the lower bearing 25 are, as shown in FIGS. 26 and 27, installed on the upper and lower portions of the cylinder 21 respectively, and rotatably support the driving shaft 12 using a sleeve and the penetrating holes 24b and 25b formed inside the sleeve. In more detail, the upper bearing 24, the lower bearing 25 and the cylinder 21 include a plurality of coupling holes 24a, 25a and 21a formed to correspond to each other respectively. The cylinder 21, the upper bearing 24 and the lower bearing 25 are firmly coupled with one another to seal the cylinder inner volume, especially the fluid chamber 29 using coupling members such as bolts and nuts.

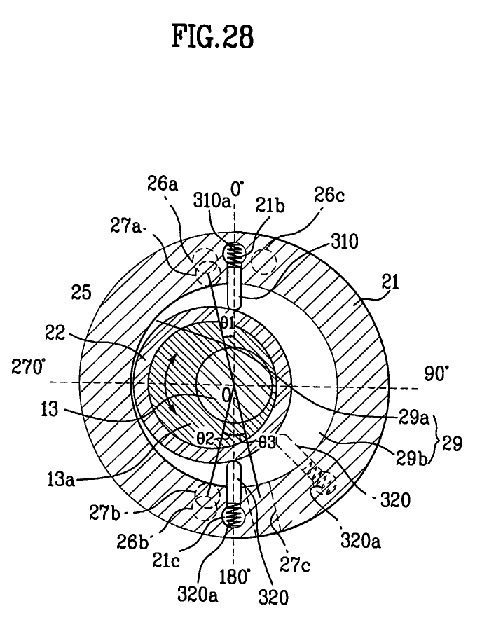

The vane 300 includes two first and second vanes 310 and 320 installed in the cylinder 21. As aforementioned, the first and second vanes 310 and 320 are installed within the grooves 21b and 21c of the cylinder 21. Elastic members 310a and 320a are also installed in the grooves 21b and 21c to elastically support the vanes 310 and 320. The vanes 310 and 320 continuously contact the roller 22. In other words, the elastic members 310a and 320a have one ends fixed to the cylinder 21 and the other ends coupled with the vanes 310 and 320, and pushes the vanes 310 and 320 toward the roller 22. Accordingly, the vanes 310 and 320 divide the fluid chamber 29 into two separate first and second spaces 29a and 29b as shown in FIG. 28. Since the vanes 310 and 320 are always in contact with the roller 22, the first and second spaces 29a and 29b are separated completely independently with the revolution direction (the rotational direction of the driving shaft 13) of the roller 22. In other words, the first and second spaces 29a and 29b can suck, compress and discharge independently. Thus, since the first and second spaces 29a and 29b are independent from each other, the compression in the first and second spaces 29a and 29b in each rotational direction of the driving shaft 13 can be adjusted so as to change the compression capacity of the compressor. In other words, the first space 29a is configured to compress the fluid in both of the clockwise direction and the counterclockwise direction, whereas the second space 29b is configured to compress the fluid in any one of the clockwise direction and the counterclockwise direction of the driving shaft. Accordingly, according to the rotational direction of the driving shaft 13, the compression capacity is varied, so that the vane 300 acts as the predefined compression mechanism of the invention.

In more detail, for the compression of the fluid in bidirections of the driving shaft 13, discharge and suction ports 26a, 26b, 27a, 27b to suck and discharge the fluid depending on the rotational direction of the driving shaft 13 are provided in the first space 29a.

First, discharge ports 26a and 26b are formed on the upper bearing 24. The discharge ports 26a and 26b communicate with the first space 29a such that the compressed fluid is discharged. The discharge ports 26a and 26b can communicate directly with the first space 29a, and can communicate with the fluid chamber 29 through a predetermined length of passage 21d formed on the cylinder 21 and the upper bearing 24.

As shown in more detail in FIG. 28, the inventive compressor includes at least two first and second discharge ports 26a and 26b. Although the roller 22 revolves any one of the clockwise direction and the counterclockwise direction within the first space 29a, it is required that one discharge port should be provided between the suction port and the vane 300 located within the revolution path so as to discharge the compressed fluid. Accordingly, one discharge port is needed every rotational direction (clockwise direction and the counterclockwise direction). For this purpose, the respective first and second discharge ports 26a and 26b are located so as to discharge the fluid in the corresponding rotational direction. The aforementioned first and second discharge ports 26a and 26b allow the inventive compressor to discharge the fluid regardless of the revolution direction (i.e., rotational direction of the driving shaft 13) of the roller 22. In other words, in the first space 29a, the fluid is discharged from the first discharge port 26a while the driving shaft rotates in any one direction (clockwise direction on the drawing) and is discharged from the second discharge port 26b while the driving shaft 13 rotates in other directional rotation (counterclockwise direction on the drawing). Also, the discharge ports 26a and 26b are preferably formed in the vicinity of the vane 300 to discharge the maximum compressed fluid in each rotational direction of the driving shaft 13. In other word, as shown in the drawings, the first discharge port 26a is located in the vicinity of the first vane 310 and the second discharge port 26b is located in the vicinity of the second vane 320. The discharge ports 26a and 26b are preferably positioned in the vicinity of the vanes 310 and 320 if possible.

Suction ports 27a and 27b communicating with the first space 29a are formed on the lower bearing 25. The suction ports 27a and 27b guide the fluid to be compressed to the first space 29a. The suction ports 27a and 27b are connected to the suction pipe 7 so that the fluid outside the compressor can be introduced into the chamber 29. In more concrete, the suction pipe 7 is branched into a plurality of auxiliary pipes 7a and the auxiliary pipes 7a are connected to suction ports 27a and 27b respectively. If necessary, the discharge ports 26a and 26b may be formed on the lower bearing 25 and the suction ports 27a and 27b may be formed on the upper bearing 24.

As shown in detail in FIG. 28, the suction ports 27a and 27b are positioned properly so that the fluid can be compressed between the discharge ports 26a and 26b and the roller 22. Actually, the fluid is compressed from any one of the suction ports to any one of the discharge ports positioned in the revolution path of the roller 22. Accordingly, in order to obtain a compression capacity from the first space 29a in all rotational directions (clockwise and counterclockwise directions) of the driving shaft 13, at least one suction port for corresponding discharge port in each rotational direction of the driving shaft 13 is requested. To this end, the compression of the present invention has first and second suction ports 27a and 27b corresponding to two discharge ports 26a and 26b respectively and for sucking the fluid into the first space 29a in a corresponding rotational direction of the driving shaft 13.

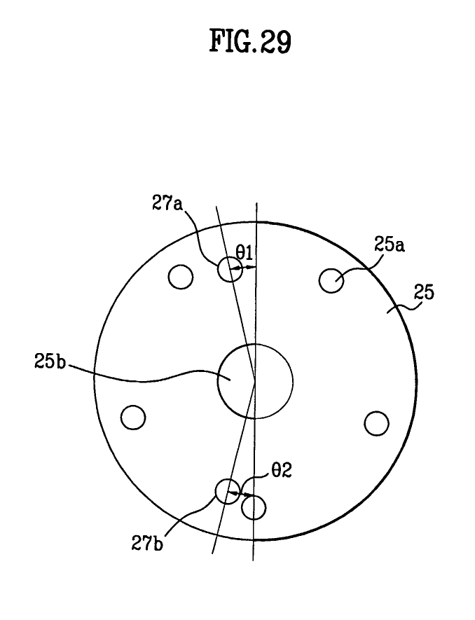

Also, as aforementioned, since the fluid is compressed between the suction port and the discharge port that are operatably linked while the driving shaft rotates in any one direction, relative position of the suction portion to the corresponding discharge port determines the compression capacity. In other words, once the position of the discharge valve is determined, the position of the suction port determines the compression capacity. Accordingly, in order to secure a compression capacity as large as possible in each directional rotation of the driving shaft 13, it is preferable that the first and second suction ports 26a and 26b are located in the vicinity of the vane 300. In other words, as shown in the drawings, like the discharge ports 26a and 26b, the suction ports 27a and 27b are respectively located in the vicinity of the first and second vanes 310 and 320. In more detail, as shown in FIGS. 28 and 29, the first suction port 27a is actually spaced apart by an angle θ1 of 10° clockwise or counterclockwise from the vane 300. In the drawings of the present invention, there is shown the first suction port 27a spaced apart by the angle θ1 counterclockwise. Similarly to the first suction port 27a, the second suction port 27b is spaced apart by an angle θ1 of 10° clockwise or counterclockwise from the vane 300. The second suction port 27b is located communicating with the first space 29a, i.e., spaced apart from the vane 300 clockwise on the drawings such that the fluid is compressed in all rotational directions in the first space 29a. These suction ports are generally a circular shape and preferably have a diameter 6-15 mm. In order to increase a suction amount of fluid, the suction ports 27a and 27b can also be provided in several shapes, including a rectangle. Resultantly, the roller 22 compresses the fluid from the first suction port 27a to the second discharge port 26b in any one directional rotation (counterclockwise direction on the drawing). And, the roller 22 compresses the fluid from the second suction port 27b to the first discharge port 27a in any other directional rotation (clockwise direction on the drawing). By the aforementioned discharge and suction ports, compression is carried out in the first space 29a while the driving shaft 13 rotates bidirectionally. Also, the roller 22 compresses the fluid in the first space 29a by using the entire portion of the fluid chamber 29. In other words, refrigerant of an amount corresponding to the entire volume of the fluid chamber 29 can be compressed.

Also, in the second space 29b, there are provided discharge and suction ports 26c and 27c for sucking and discharging the fluid to be compressed only in any one direction of the driving shaft 13.

As shown in FIGS. 26, 27 and 28, the discharge port 26c and the suction port 27c are respectively formed on the upper bearing 24 and the lower bearing 25 so as to communicate with the second space 29b. The discharge port 26c can communicate directly with the second space 29b or can communicate with the second space 29b through a predetermined fluid passage 21d formed on the upper bearing 24. The suction port 27c can be connected directly with the suction pipe 7 or be connected with one of a plurality of auxiliary pipes 7a branched from the suction pipe 7 like the suction ports 26a and 26b. If necessary, the discharge port 26 may be formed on the lower bearing 25 and the suction port 27c may be formed on the upper bearing 24.

As aforementioned, compression capacity in any one directional rotation of the driving shaft in a rotary compressor is obtained between one suction port and one discharge port that are located on the revolution path of the roller 22. Since the second space 29b is for compressing the fluid in any one direction of the driving shaft 13, only one suction port and one discharge port that are functionally linked with each other so as to be able to compress the fluid are requested. Owing to the aforementioned reason, in the inventive compressor, the second space 29b has a third discharge port 27c and a third suction port 27c.

As shown in FIG. 28, these third discharge and suction ports 26c and 27c are spaced apart by a predetermined distance within the second space 29b such that the fluid can be compressed therebetween. First, the third discharge port 26c is preferably formed in the vicinity of one of the vanes 310 and 320 within the range of the second space 29b so as to discharge the fluid compressed to the maximum. In FIG. 28, there is shown the third discharge port 26c arranged in the vicinity of the first vane 310 and accordingly the fluid compressed while the driving shaft 13 rotates counterclockwise is discharged. The third discharge ports 26c is preferably located as close as possible. Also, as aforementioned, once the location of the discharge valve is determined, the location of the suction port determines the compression capacity. Accordingly, in order to secure a compression capacity as large as possible in the second space 29b, the third suction port 27c is preferably located in the vicinity of any one of the vanes 310 and 320. Here, the third suction port 27c should be spaced apart by a predetermined angle from the third discharge port 26c for the compression of the fluid. Accordingly, since the third discharge port 26c is placed in the vicinity of the first vane 310 in FIG. 28, the third suction port 27c is placed in the vicinity of the second vane 320. In more detail, the third suction port 27c is substantially spaced apart by an angle θ3 of 10° clockwise or counterclockwise from the second vane 320. In the drawings of the invention, there is shown the first suction port 27a spaced apart by the angel θ3 of 10° clockwise or counterclockwise so as to be placed within the second space 29b. Like the suction ports 26a and 26b, this suction port 27c is generally a circular shape and preferably has a diameter 6-15 mm. Also, in order to increase a suction amount of fluid, the suction port 27c can also be provided in several shapes, including a rectangle. Resultantly, the roller 22 compresses the fluid from the third suction port 27c to the third discharge port 26c in any one directional rotation (counterclockwise direction on the drawing). On the contrary, since the roller 22 rotates from the third discharge port 26c to the third suction port 27c in any other directional rotation (clockwise direction on the drawing) of the driving shaft 13, the fluid is not compressed. By the aforementioned discharge and suction ports, compression is carried out in the second space 29b while the driving shaft 13 rotates only in any one direction. However, since the suction and discharge ports 26c and 27c are placed in the vicinity of the vanes 310 and 320, the roller 22 compresses the fluid by using the entire portion of the second space 29b while the driving shaft 13 rotates only in any one direction. In other words, refrigerant of an amount corresponding to the entire volume of the second space 29b can be compressed.

Resultantly, in the third embodiment, the suction and discharge ports selectively supply the first and second spaces 29a and 29b with fluid and discharge the fluid from the first and second spaces 29a and 29b such that each of compressions in the first and second spaces 29a and 29b is independently performed depending on the rotational direction of the driving shaft 13. Accordingly, the suction and discharge ports substantially and auxiliarily assist the function of the vane 300 that is the compression mechanism.

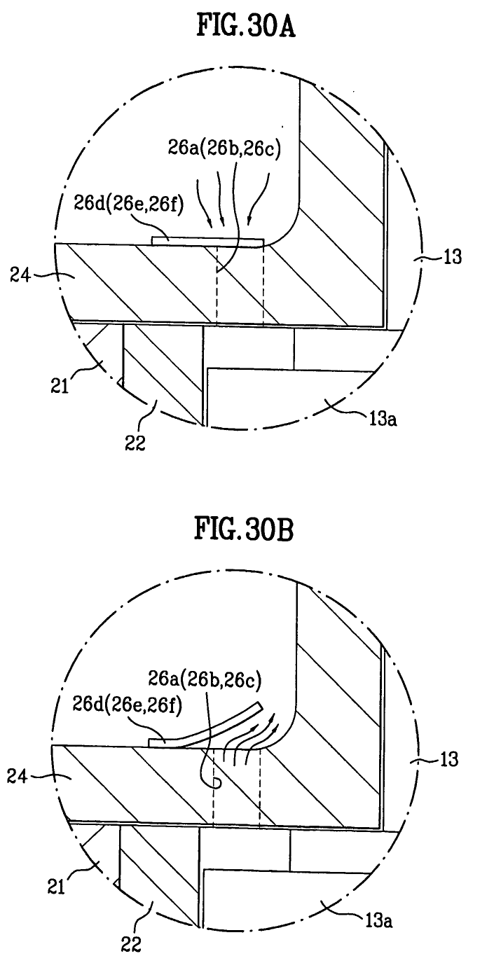

In order to open and close these discharge ports 26a, 26b and 26c, discharge valves 26d, 26e and 26f are installed on the upper bearing 24 as shown in FIGS. 26 and 27. The first discharge valve 26d opens and closes the first discharge port 26a, the second discharge valve 26e opens and closes the second discharge port 26b, and the third discharge valve 26f opens and closes the third discharge port 26c, respectively. FIGS. 30A and 30 are sectional views illustrating operations of these discharge valves 26d, 26e and 26f. The discharge valves 26d, 26e and 26f are configured to open the discharge ports 26a, 26b and 26c when a positive pressure which is greater than or equal to a predetermined pressure is generated in the inside of the cylinder 21. To achieve this, it is desirable that the discharge valves 26d, 26e and 26f are a check valve allowing only a flow of fluid to the outside of the cylinder 21. Also, the discharge valves 26d, 26e and 26f may be a plate valve of which one end is fixed in the vicinity of the discharge ports 26a, 26b and 26c and the other end can be deformed freely. Then, in case a relatively high pressure is generated outside the cylinder 21, the discharge valves 26d, 26e and 26f functioning as a plate valve are installed to be confined by the upper bearing 24. In more detail, as shown in FIG. 30A, if a negative pressure is generated inside the first space 29a or the second space 29b, the discharge valves 26d, 26e and 26f are deformed toward the cylinder 21 due to the pressure (atmospheric pressure) outside the cylinder 21 that is relatively high. However, the discharge valves 26d, 26e and 26f are confined by the upper bearing 24 and are not deformed but are placed closely around the discharge ports 26a, 26b and 26c on its behalf to close the discharge ports 26a, 26b and 26c more firmly. Also, in case a relatively low positive pressure is generated in the cylinder 21, the discharge ports 26a, 26b and 26c continue to be closed by the self-elasticity of the discharge valves 26c and 26d. After that, if a positive pressure above a predetermined value, i.e., a positive pressure that is larger than the elasticity of the discharge valves 26d, 26e and 26f is generated, the discharge valves 26d, 26e and 26f are deformed so as to open the discharge ports 26a, 26b and 26c as shown in FIG. 30B. Accordingly, only when the pressures of the first and second spaces 29a and 29b are above a predetermined positive pressure, the discharge valves 26d, 26e and 26f selectively open the discharge ports 26a, 26b and 26c. Although not shown in the drawings, a retainer for restricting the deformable amount of the valves may be installed on the upper portion of the discharge valves 26d, 26e and 26f so that the valves can operate stably. In addition, a muffler (not shown) may be installed on the upper portion of the upper bearing 24 to reduce a noise generated when the compressed fluid is discharged.

In order to close the suction ports 27a and 27b, suction valves 27d and 27e are installed between the cylinder 21 and the lower bearing 25 as shown in FIGS. 26 and 27. In other words, the first suction valve 27d is installed to open and close the first suction port 27a, and the second suction valve 27e is installed to open and close the second suction port 27b. If the suction ports 27a and 27b are formed on the upper bearing 24, the first and second suction valves 27d and 27e are installed between the cylinder and the upper bearing 24. In the meanwhile, since the fluid compression does not occur in the second space 29b in the other directional rotation (clockwise direction on FIG. 28) of the driving shaft 13, the third suction port 27c is not necessarily closed to prevent the fluid from being leaked outside the cylinder 21 during such a rotation. Accordingly, it is preferable for a simple structure that the suction valve such as the first and second suction valves 27d and 27e are not installed in the third suction port 27c. By the same reason, the third suction port 27c may be formed to penetrate a sidewall of the cylinder 21 instead of the lower bearing 25 as shown in the drawings.

Basically, so as for the fluid to be sucked into the inside of the cylinder 21, i.e., into the first and second spaces 29a and 29b, the inner pressure of the cylinder 21 should be lower than the outer pressure (atmospheric pressure) of the cylinder 21. Accordingly, the suction valves 27d and 27e are configured to open the suction ports 27a and 27b when a pressure difference between the inside and the outside of the cylinder 21, more precisely, a negative pressure above a predetermined pressure is generated in the cylinder 21. To achieve this, the suction valves 27d and 27e may be a check valve allowing one directional flow due to a pressure difference, i.e., fluid flow into the inside of the cylinder 21. In the meanwhile, the suction valves 27d and 27e may be a plate valve similarly with the discharge valves 26d, 26e and 26f. In the invention, the plate valve is preferable since it can perform the same function with more simple and higher response. The suction valves 27d and 27e are deformable by the external pressure of the cylinder 21 that is relatively high only in case a negative pressure is generated within the cylinder 21. On the contrary, in case a positive pressure is generated inside the cylinder 21, the suction valves 27d and 27e are confined by the lower bearing 25 so as not to be deformed. Also, the suction valves 27d and 27e may be provided with a retainer for restricting deformation of the second ends. In the present invention, the retainer may be an independent member, but is preferably simple structured grooves 28 formed in the cylinder 21. The grooves 28 extend with a slope in the length direction of the valves 27d and 27e, and the valves, more accurately, the second ends are received in the grooves 28 as deformed. Accordingly, the grooves 28 restrict an excessive deformation of the valves 27d and 27e due to an abrupt pressure variation to thereby allow the valves 27d and 27e to operate stably.

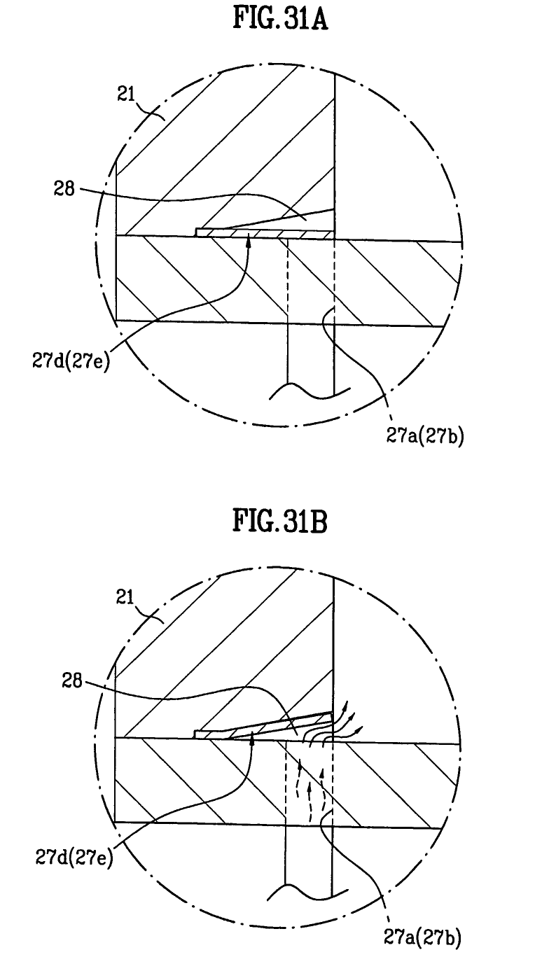

As shown in FIG. 31A, if a positive pressure is generated inside the first space 29a, the valves 27d and 27e are deformed toward the lower bearing 25. However, the valves 27d and 27e are confined by the upper bearing 24 and are not deformed, but close the suction ports 27a and 27b more firmly. Also, in case a relatively low negative pressure is generated in the cylinder 21, the suction ports 27a and 27b continue to be closed by the self-elasticity of the suction valves 27d and 27e. After that, if a negative pressure above a predetermined value, i.e., a negative pressure that is larger than the elasticity of the valves 27d and 27e is generated, the valves 27d and 27e are deformed toward the cylinder 21 as shown in FIG. 31B such that the suction ports 27a and 27b are opened to suck fluid. Resultantly, the suction valves 27d and 27e open the suction ports 27a and 27b by using the negative pressure of the inside of the cylinder 21

Meanwhile, as described above with reference to FIGS. 26 and 27, the suction ports 27a, 27b and 27c are individually connected with a plurality of suction pipes 7a so as to supply fluid to the fluid chamber 29 inside the cylinder 21. However, the number of parts increases due to these suction pipes 7a, thus making the structure complicated. In addition, fluid may not be properly supplied to the cylinder 21 due to a change in a compression state of the suction pipes 7b separated during operation. Accordingly, as expressed by a dotted line on FIG. 26, it is desirable that the compressor includes a suction plenum 500 for preliminarily storing fluid to be sucked by the compressor. Such the suction plenum 500 forms a space in which a predetermined amount of fluid is always stored, so that a pressure variation of the sucked fluid is buffered to stably supply the fluid to the suction ports 27a, 27b and 27c. In addition, the suction plenum 500 can accommodate oil extracted from the stored fluid and thus assist or substitute for the accumulator 8.

Hereinafter, operation of a rotary compressor according to a third embodiment of the present invention will be described in more detail.

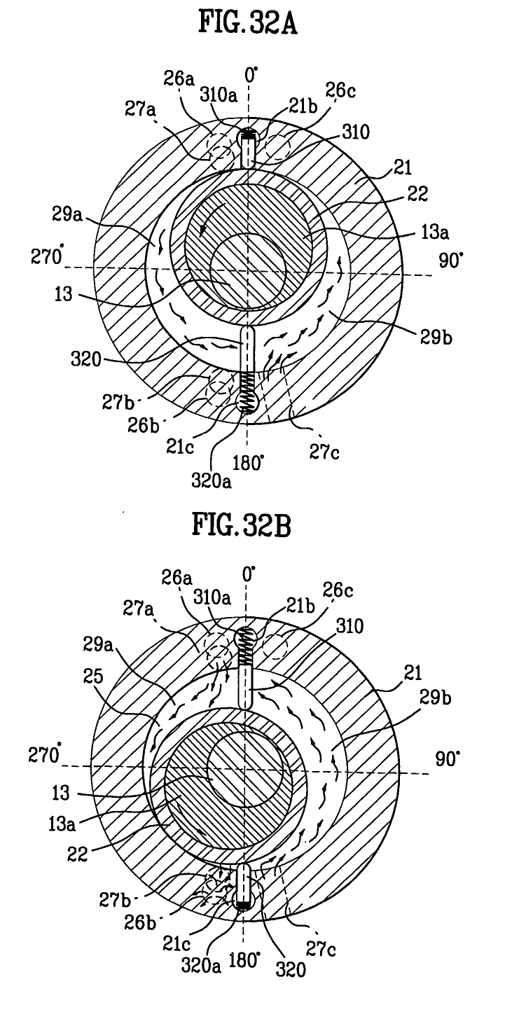

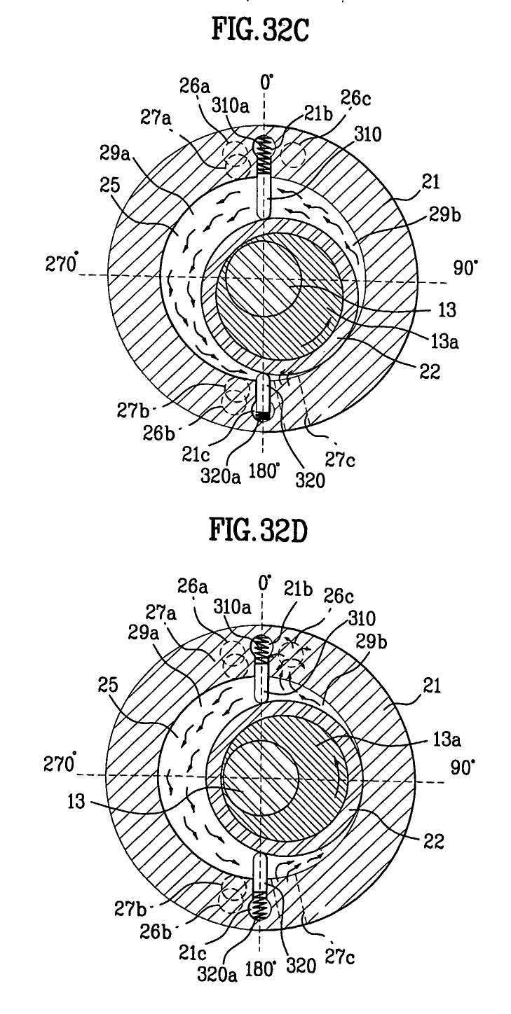

FIGS. 32A to 32D are cross-sectional views sequentially illustrating insides of the cylinder when the roller revolves in the counterclockwise direction in the rotary compressors according to a third embodiment of the present invention.

First, in FIG. 32A, there are shown states of respective elements inside the cylinder when the driving shaft 13 begins to rotate in the counterclockwise direction. Since there is no pressure variation in the cylinder 21, the suction and discharge ports are closed by the respective valves. Since operations of the respective valves in the counterclockwise rotation have been described with reference to FIGS. 30A to 31B in the above, its detailed description will be omitted.

The roller 22 revolves counterclockwise with performing a rolling motion along the inner circumference of the cylinder 21 due to the rotation of the driving shaft 13. As the roller 22 continues to revolve, the size of the space 29b is reduced as shown in FIG. 32B and thus the fluid that has been sucked is compressed. Due to the compression, a positive pressure is generated in the space 29b around the second discharge and suction ports 26b and 27b and accordingly the second suction port 27b is more firmly closed. At the same time, as a negative pressure is generated in the space 29a around the first discharge and suction ports 26a and 27a, the first suction port 27a is opened and the first discharge port 26a is closed. New fluid continues to be sucked into the space 29a through the first suction port 27a so as to be compressed in a next stroke.

When the fluid pressure in the space 29a is above a predetermined value, the second discharge port 26b is opened and as shown in FIG. 32B, the fluid is discharged through the second discharge port 26b. After the fluid is completely discharged, the second discharge valve 26e closes the second discharge port 26b by its self-elasticity.

As the roller 22 continues to revolve, the size of the space 29b is reduced as shown in FIG. 32C and thus the fluid that has been sucked into the second space 29b begins to be compressed. Due to the compression, a positive pressure is generated in the second space 29b around the third discharge port 26c. At the same time, as a negative pressure is generated in the second space 29b around the third suction port 27c, new fluid continues to be sucked into the second space 29b through the opened third suction port so as to be compressed in a next stroke.

When the fluid pressure in the space 29b is above a predetermined value, the third discharge port 26c is opened and as shown in FIG. 32D, the fluid is discharged through the third discharge port 26c. As the roller 22 continues to revolve, all the fluid in the space 29b is discharged through the third discharge port 26c. After the fluid is completely discharged, the third discharge valve 26f closes the third discharge port 26c by its self-elasticity. In the series of steps, the first and second vanes 310 and 320 moves up and down elastically by the elastic members 310a and 320a to thereby partition the fluid chamber 29 into the two sealed spaces 29a and 29b. Accordingly, the suction and compression of the fluid in the first and second spaces 29a and 29b are performed independently.

Thus, after a single stroke is ended, the roller 22 continues to revolve counterclockwise and discharges the fluid by repeating the same stroke. In the counterclockwise stroke, the roller 22 compresses the fluid with revolving from the first suction port 27a to the second discharge port 26b in the first space 29a. In the second space 29b, the roller 22 compresses the fluid with revolving from the third suction port 27c to the third discharge port 26c. Also, as aforementioned, the first and third suction ports 27a and 27c and the second and third discharge ports 27b and 27c are positioned in the vicinity of the corresponding vanes 310 and 320. Accordingly, the fluid is substantially compressed using the overall volume of the fluid chamber 29 in the counterclockwise stroke and thus a maximal compression capacity is obtained.

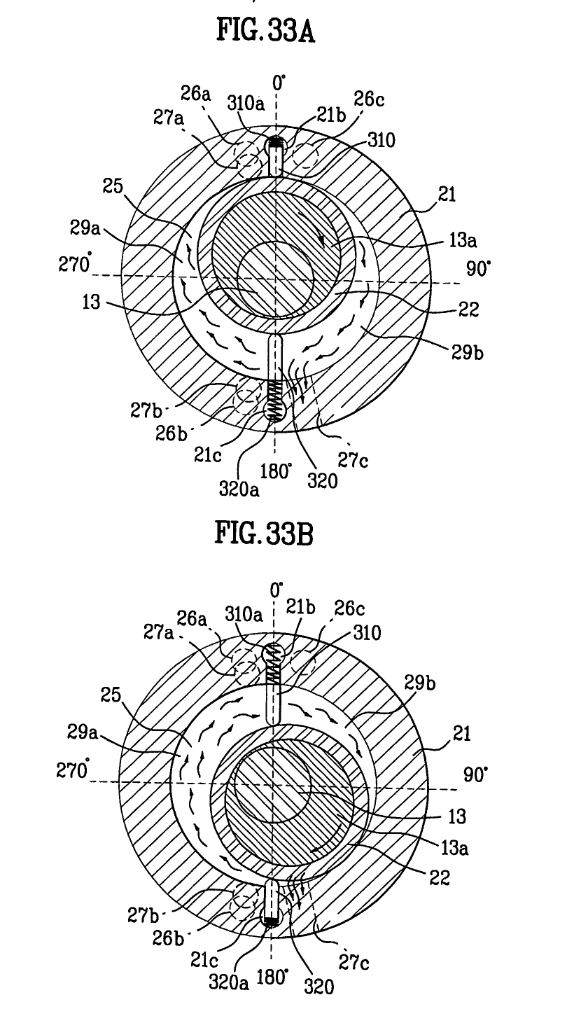

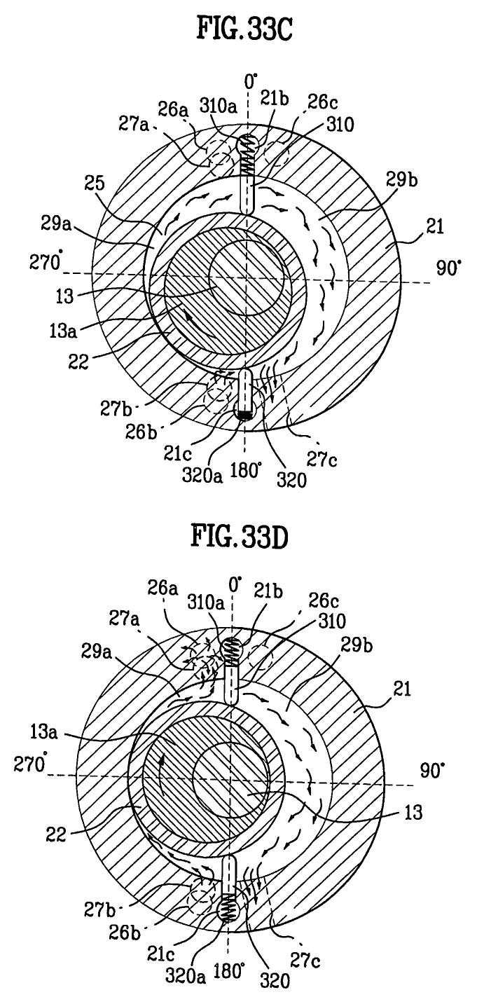

FIGS. 33A to 33D are cross-sectional views sequentially illustrating insides of the cylinder when the roller revolves in the clockwise direction in the rotary compressors according to a third embodiment of the present invention.

First, in FIG. 33A, there are shown states of respective elements inside the cylinder when the driving shaft 13 rotates in the clockwise direction. Since there is no pressure variation in the cylinder 21, the suction and discharge ports are closed by the respective valves as aforementioned. Since operations of the respective valves in the counterclockwise rotation have been described with reference to FIGS. 30A to 31B in the above, its detailed description will be omitted.

The roller 22 begins to revolve clockwise with performing a rolling motion along the inner circumference of the cylinder 21 due to the rotation of the driving shaft 13. In such a revolution, the fluid that has been sucked into the second space 29b is not compressed but is forcibly exhausted outside the cylinder 21 by the roller 22 through the opened second suction port 27b as shown in FIG. 33B. Accordingly, the fluid cannot be compressed in the second space 29b.

As the roller 22 continues to revolve, the fluid that has been sucked into the first space 29a is compressed. Due to the compression, a positive pressure is generated in the first space 29a around the first discharge and suction ports 27a and 27a. Accordingly, the first suction port 27a is closed more firmly. At the same time, a negative pressure is generated in the first space 29a around the second discharge and suction ports 26b and 27b, so that the second suction port 27b is opened and the second discharge port 26b is closed more firmly. New fluid continues to be sucked into the first space 29a through the opened second suction port 27b so as to be compressed in a next stroke.

When the fluid pressure in the space 29b is above a predetermined value, the first discharge port 26a is opened and as shown in FIG. 33D, the fluid is discharged through the first discharge port 26a. As the roller 22 continues to revolve, all the fluid in the space 29a is discharged through the first discharge port 26a. After the fluid is completely discharged, the first discharge valve 26a closes the first discharge port 26a by its self-elasticity.

In the series of steps, the first and second vanes 310 and 320 moves up and down elastically by the elastic members 310a and 320a to thereby partition the fluid chamber 29 into the two sealed spaces 29a and 29b. Accordingly, the suction and compression of the fluid in the first and second spaces 29a and 29b are performed independently.

Thus, after a single stroke is ended, the roller 22 continues to revolve clockwise and discharges the fluid by repeating the same stroke. In the clockwise stroke, the roller 22 compresses the fluid with revolving from the second suction port 27b to the first discharge port 26a in the first space 29a. On the contrary, the fluid compression in the second space 29a does not occur. Accordingly, the fluid is compressed using a part (i.e., first space 29a) of the overall fluid chamber 29 in the clockwise stroke, so that a compression capacity that is smaller than that in the clockwise direction is obtained. In the meanwhile, since the second vane 320 is located spaced apart by an angle of 180° so as to face the first vane 310, the sizes of the first space 29a and the second space 29b are equal to each other. Thus, since the second space 29b is used for the compression in the clockwise rotation, the compression capacity in the clockwise direction corresponds to half a compression capacity in the counterclockwise direction. However, as expressed by a dotted line on FIG. 28, if the second vane 320 is spaced apart by a predetermined angle (less than 180°) from the first vane 310 clockwise or counterclockwise along with the second and third suction ports 27b and 27c and the second discharge port 27b, the size of the second space 29b increases or decreases. Accordingly, since the compression capacity in the clockwise rotation is in inverse proportional to the size of the second space 29b, it becomes small or large. Resultantly, by controlling the relative position of the second vane 320 to the first vane 310, it is possible to control the compression capacity in the clockwise direction.

In the aforementioned strokes (i.e., the clockwise stroke and the counterclockwise stroke), the discharged compressive fluid moves upward through the space between the rotor 12 and the stator 11 inside the case 1 and the space between the stator 11 and the case 1. Finally, the compressed fluid is discharged through the discharge pipe 9 out of the compressor.

In the aforementioned third embodiment, the inventive rotary compressor has two vanes partitioning the fluid chamber and suction and discharge ports for selectively sucking and discharging the fluid into the partitioned spaces according to the rotational direction of the driving shaft. Accordingly, although the driving shaft rotates in any one of the counterclockwise direction and clockwise direction, the fluid can be compressed. Also, different sizes of compression spaces are formed depending on the rotational direction of the driving shaft such that different compression capacities are obtained in its operation. In particular, any one of the compression capacities is formed using the predesigned entire fluid chamber.

### Fourth Embodiment

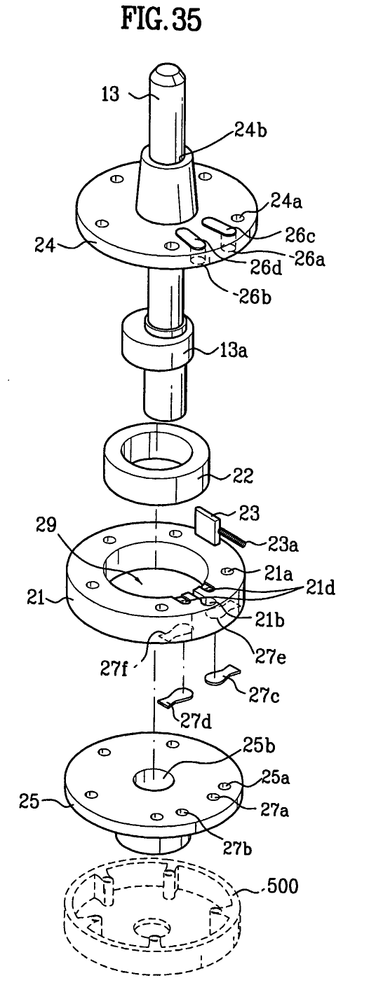

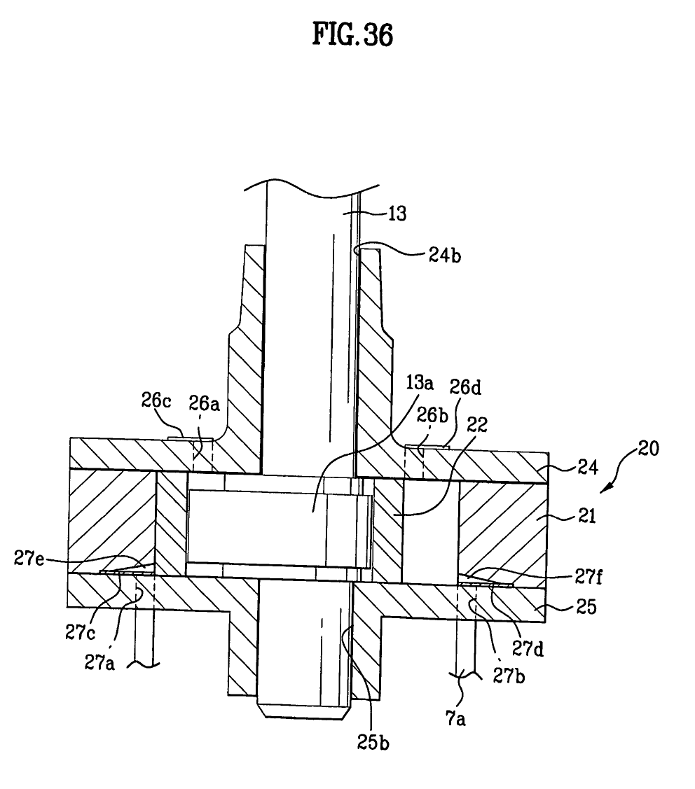

FIG. 35 is an exploded perspective view illustrating the compression unit of the rotary compressor according to a fourth embodiment of the present invention and FIG. 36 is a sectional view illustrating the compressing unit according to a fourth embodiment of the present invention.

In the fourth embodiment, the cylinder 21 has a predetermined inner volume and a strength enough to endure the pressure of the fluid to be compressed. The cylinder 21 accommodates an eccentric portion 13a formed on the driving shaft 13 in the inner volume. The eccentric portion 13a is a kind of an eccentric cam and has a center spaced by a predetermined distance from its rotation center. The cylinder 21 has a groove 21b extending by a predetermined depth from its inner circumference. A vane 23 to be described below is installed in the groove 21b. The groove 21b is long enough to accommodate the vane 23 completely.

The roller 22 is a ring member that has an outer diameter less than the inner diameter of the cylinder 21. As shown in FIG. 17, the roller 22 contacts the inner circumference of the cylinder 21 and rotatably coupled with the eccentric portion 13a. Accordingly, the roller 22 performs rolling motion on the inner circumference of the cylinder 21 while spinning on the outer circumference of the eccentric portion 13a when the driving shaft 13 rotates. The roller 22 revolves spaced apart by a predetermined distance from the rotation center ‘0’ due to the eccentric portion 13a while performing the rolling motion. Since the outer circumference of the roller 22 always contacts the inner circumference due to the eccentric portion 13a, the outer circumference of the roller 22 and the inner circumference of the cylinder form a separate fluid chamber 29 in the inner volume. The fluid chamber 29 is used to suck and compress the fluid in the rotary compressor.

The vane 23 is installed in the groove 21b of the cylinder 21 as described above. An elastic member 23a is installed in the groove 21b to elastically support the vane 23. The vane 23 continuously contacts the roller 22. In other words, the elastic member 23a has one end fixed to the cylinder 21 and the other end coupled with the vane 23, and pushes the vane 23 to the side of the roller 22. Accordingly, the vane 23 divides the fluid chamber 29 into two separate spaces 29a and 29b as shown in FIG. 17. While the driving shaft 13 rotate or the roller 22 revolves, the volumes of the spaces 29a and 29b are changed complementarily. In other words, if the roller 22 rotates clockwise, the space 29a gets smaller but the other space 29b gets larger. However, the total volume of the spaces 29a and 29b is constant and approximately same as that of the predetermined fluid chamber 29. One of the spaces 29a and 29b works as a suction chamber for sucking the fluid and the other one works as a compression chamber for compressing the fluid relatively when the driving shaft 13 rotates in one direction (clockwise or counterclockwise). Accordingly, as described above, the compression chamber of the spaces 29a and 29b gets smaller to compress the previously sucked fluid and the suction chamber expands to suck the new fluid relatively according to the rotation of the roller 22. If the rotational direction of the roller 22 is reversed, the functions of the spaces 29a and 29b are exchanged. In the other words, if the roller 22 revolves counterclockwise, the right space 29b of the roller 22 becomes a compression space, but if the roller 22 revolves clockwise, the left space 29a of the roller 22 becomes the compression space.

The upper bearing 24 and the lower bearing 25 are, as shown in FIG. 35, installed on the upper and lower portions of the cylinder 21 respectively, and rotatably support the driving shaft 12 using a sleeve and the penetrating holes 24b and 25b formed inside the sleeve. In more detail, the upper bearing 24, the lower bearing 25 and the cylinder 21 include a plurality of coupling holes 24a, 25a and 21a formed to correspond to each other respectively. The cylinder 21, the upper bearing 24 and the lower bearing 25 are coupled with one another to seal the cylinder inner volume, especially the fluid chamber 29 using coupling members such as bolts and nuts.

Discharge ports 26a and 26b are formed on the upper bearing 24. The discharge ports 26a and 26b communicate with the fluid chamber 29 such that the compressed fluid can be discharged. The discharge ports 26a and 26b can communicate directly with the fluid chamber 29 or can communicate with the fluid chamber 29 through a predetermined fluid passage 21d formed in the cylinder 21 and the upper bearing 24.

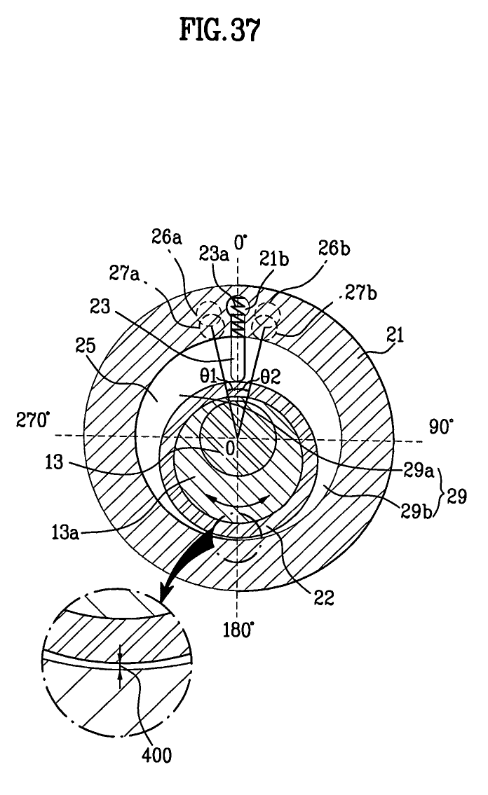

As shown more detail in FIG. 37, the compressor of the present invention includes at least two discharge ports 26a and 26b. Even if the roller 22 revolves in any direction, a discharge port should exist between the suction port and vane 23 positioned in the revolution path to discharge the compressed fluid. Accordingly, one discharge port is necessary for each rotational direction (clockwise and counterclockwise). To achieve this, the first and second discharge ports 26a and 26b are positioned to discharge the fluid in the corresponding rotational direction. These first and second discharge ports 26a and 26b cause the compressor of the present invention to discharge the fluid regardless of the revolution direction of the roller 22 (that is, the rotational direction of the driving shaft 13). In other words, the fluid is discharged from the first discharge port 26a when rotating in any one direction (clockwise in the drawing) of the driving shaft 13. Meanwhile, as described above, the compression chamber of the spaces 29a and 29b gets smaller to compress the fluid as the roller 22 approaches the vane 23. Accordingly, the discharge ports 26a and 26b are preferably formed facing each other in the vicinity of the vane 23 to discharge the maximum compressed fluid. In other word, as shown in the drawings, the discharge ports 26a and 26b are positioned on both sides of the vane 23 respectively. The discharge ports 26a and 26b are preferably positioned in the vicinity of the vane 23 if possible.

Referring to FIGS. 35 and 36 again, the suction ports 27a and 27b communicating with the fluid chamber 29 are formed on the lower bearing 25. The suction ports 27a and 27b guide the fluid to be compressed to the fluid chamber 29. The suction ports 27a and 27b are connected to the suction pipe 7 so that the fluid outside of the compressor can flow into the chamber 29. More particularly, the suction pipe 7 is branched into a plurality of auxiliary pipes 7a and the branched auxiliary pipes 7a are connected to the suction ports 27 respectively. If necessary, the discharge ports 26a and 26b may be formed on the lower bearing 25 and the suction ports 27a and 27b may be formed on the upper bearing 24.

As shown in FIG. 27 in detail, these suction ports 27a and 27b are positioned properly so that the fluid can be compressed between the discharge ports 26a and 26b and the roller 22. Actually, the fluid is compressed from a suction port to a discharge port positioned in the revolution path of the roller 22.

Accordingly, to obtain compression capacity in all rotational directions (clockwise and counterclockwise) of the driving shaft 13, at least one suction port is required for the corresponding discharge port in each rotational direction of the driving shaft 13. Due to the reasons, the compressor of the present invention includes the first and second suction ports 27a and 27b for sucking the fluid in the corresponding rotational direction of the driving shaft 13 for each of the two discharge ports 26a and 26b.

As described above, since the fluid is compressed between the suction port and the discharge port connected with each other to be operatable in rotation of the driving shaft in one direction, the relative position of the suction port for the corresponding discharge port determines the compression capacity. In other words, once the position of the discharge valve is determined, the position of the suction port determines compression capacity. To obtain large compression capacity as possible in the rotation of the driving shaft in each direction, the first and second suction ports 26a and 26b are preferably positioned in the vicinity of the vane 23. In other words, as shown in drawings, the suction ports 27a and 27b are positioned on both sides of the vane 23. More particularly, the first suction port 27a is actually spaced apart by an angle θ1 of 10° clockwise or counterclockwise from the vane 23 as shown in FIG. 37. The drawings of the present invention illustrates the first suction port 27a spaced apart by the angle θ1 counterclockwise. The second suction port 27b is spaced apart by an angle θ2 of 10° clockwise or counterclockwise from the vane 23 as the first suction port 27a. The second suction port 27b is preferably positioned facing the first suction port 27a or separated from the vane 23 on drawings clockwise so that the fluid can be compressed for each rotational direction. The suction ports 27a and 27b are generally in circular shapes whose diameters are, preferably, 6-15 mm. In order to increase a suction amount of fluid, the suction ports 27a and 27b can also be provided in several shapes, including a rectangle. As a result, the roller 22 compresses the fluid from the first suction port 27a to the second discharge port 26b positioned across the vane 23 in its rotation in one direction (counterclockwise in the drawing). The roller 22 compresses the fluid from the second discharge port 26b to the first suction port 27a positioned across the vane 23 in its rotation in the other direction (clockwise in the drawing). The roller 22 compresses the fluid due to the first and second suction ports 27a and 27b by using the overall chamber 29 in rotations of the driving shaft in both directions. In other words, the refrigerant as much as overall volume of the chamber 29 is compressed.

As shown in FIG. 35 and FIG. 36, the discharge valves 26c and 26d are installed on the upper bearing 24 so as to open and close the discharge ports 26a and 26b. The discharge valves 26c and 26d are configured to open the discharge ports 26a and 26b when a positive pressure which is greater than or equal to a predetermined pressure is generated in the inside of the cylinder 21. To achieve this, it is desirable that the discharge valves 26c and 26d are plate valves one end of which is fixed in the vicinity of the discharge ports 26a and 26b and the other end of which can be deformed freely. The discharge valves 26c and 26d may be check valves allowing fluid flow to the outside of the cylinder 21. When a relatively high pressure is generated outside the cylinder 21 as shown in the drawing, the discharge valves 26c and 26d are confined to the upper bearing 24 in order not to be deformed. In more detail, as shown in FIG. 36, if a negative pressure is generated inside the chamber 29, the discharge valves 26c and 26d are deformed toward the cylinder 21 due to the relatively high pressure (atmospheric pressure) outside the cylinder 21. However, the discharge valves 26c and 26d are confined to the upper bearing 24 and are not deformed but close the discharge ports 26a and 26b more firmly on its behalf. Also, when a relatively low positive pressure is generated in the cylinder 21, the discharge ports 26a and 26b continue to be closed by the self-elasticity of the discharge valves 26c and 26d. After that, if a positive pressure higher than a predetermined value, i.e., the positive pressure that is larger than the elasticity of the discharge ports 26a and 26b is generated, the discharge valves 26c and 26d are deformed so as to open the discharge ports 26a and 26b. Accordingly, only when the pressure of the chamber 29 is higher than a predetermined positive pressure, the discharge valves 26c and 26d selectively open the discharge ports 26a and 26b. Although not shown in the drawings, a retainer for limiting the deformable amount may be installed on the upper portion of the discharge valves 26c and 26d so that the valves can operate stably. In addition, a muffler (not shown) may be installed on the upper portion of the upper bearing 24 to reduce a noise generated when the compressed fluid is discharged.

The first and second suction valves 27c and 27d are installed between the cylinder 21 and the lower bearing 25 so as to open and close the suction ports 27a and 27b. If the suction ports 27a and 27b are formed on the upper bearing 24, the first and second suction valves 27c and 27d are installed between the cylinder 21 and the upper bearing 24.

Basically, so as for the fluid to be sucked into the inside of the cylinder 21, i.e., into the inside of the fluid chamber 29, the pressure inside the cylinder 21 should be lower than the pressure (atmospheric pressure) outside the cylinder 21. Accordingly, the suction valves 27c and 27d are configured to open the suction ports 27a and 27b when a pressure difference between the inside and the outside of the cylinder 21, more precisely, a negative pressure higher than a predetermined pressure is generated in the cylinder 21. To achieve this, the suction valves 27c and 27d may be check valves allowing one directional flow due to a pressure difference, i.e., fluid flow into the inside of the cylinder 21. In the meanwhile, the suction valves 27c and 27d may be plate valves similarly with the discharge valves 26c and 26d. In the present invention, the plate valve is preferable since it can perform the same function with more simple and higher response. The suction valves 27c and 27d as shown in the drawings have first ends fixed around the suction ports 27a and 27b and second ends that are freely deformable. The suction valves 27c and 27d can be deformed due to a relatively high external pressure of the cylinder 21 only when a negative pressure is generated inside the cylinder 21. On the contrary, in case a positive pressure is generated inside the cylinder 21, the suction valves 27c and 27d are confined to the lower bearing 25 so as not to be deformed. Also, the suction valves 27c and 27d may be provided with a retainer for restricting deformation of the second ends. In the present invention, the retainer may be an independent member but is preferably simple structured grooves 27e and 27f formed in the cylinder 21. The grooves 27e and 27f extend with a slope in the length direction of the valves 27c and 27d, and the valves, more precisely, the second ends are received in the grooves 27e and 27f as deformed. Accordingly, the grooves 27e and 27f restrict an excessive deformation of the valves 27c and 27d due to an abrupt pressure variation to thereby allow the valves 210 and 220 to operate stably.

In the aforementioned suction valves 27c and 27d, if a positive pressure is generated in the cylinder 21, the suction valves 27c and 27d are deformed toward the lower bearing 25. However, the valves 27c and 27d are confined to the lower bearing 25 and are not deformed, but close the suction ports 27a and 27b more firmly on its behalf. Also, when a relatively low negative pressure is generated in the cylinder 21, the suction ports 27a and 27b continue to be closed by the self-elasticity of the suction valves 27c and 27d. After that, if a negative pressure higher than a predetermined value, i.e., a negative pressure that is larger than the elasticity of the valves 27c and 27d is generated, the valves 27c and 27d are deformed toward the cylinder 21 and the suction ports 27a and 27b are opened to suck the fluid. Accordingly, the suction valves 27d and 27e selectively open the suction ports 27a and 27b by using a pressure difference between the inside and the outside of the cylinder 21, that is, a predetermined negative pressure.

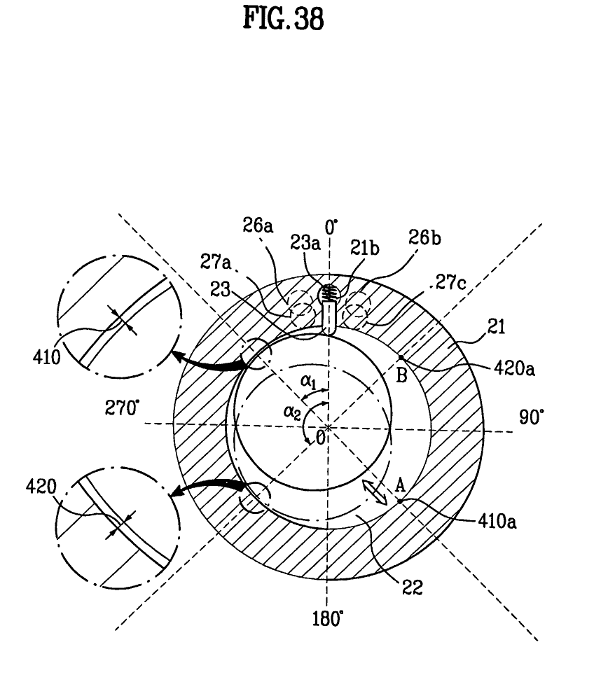

Using the ports and valves, the fluid can be compressed in both clockwise direction and counterclockwise direction of the driving shaft 13 of the compressor of the present invention. However, the same compression capacities are created in the both rotational directions. Accordingly, as shown in FIG. 38, for different compression capacities in each direction, the clearances 400 between the inner surface of the cylinder 21 and the roller 22 are formed different from each other according to the rotational direction of the driving shaft. In the present invention, the amounts of the fluid leaked in compression are different from each other according to the rotational direction due to the clearances 400 and accordingly the compression capacities results in getting different from each other. This different leakage amount brings the substantially same results in which compression space is made differently according to the rotational direction in the fluid chamber 29. As a result, the clearances 400 acts as the compression mechanism of the present invention previously defined.

As shown in FIG. 37, in the rotary compressor, a predetermined clearance 400 is formed between the roller 22 and cylinder 21 to prevent exceeding fraction between the inner surfaces of the roller 22 and cylinder 21 in operation. The clearance 400 is continuously varied between the roller 22 and the cylinder 21 so that the fluid is leaked more. It is actually difficult to form this continuous clearance and the continuous clearance can cause malfunction of the rotary compressor. The clearance 400 is preferably varied when the roller 22 is positioned at a predetermined position of the cylinder 21. More particularly, the clearance 400 of the present invention is a first clearance 410 formed to be comparatively wide at a predetermined position so as for the fluid to be leaked. When the roller 13 contacts a predetermined position of the cylinder 21, the first clearance 410 can adjust to move the driving shaft 13 towards or away from the position (depicted by an arrow mark). As described above, as the roller 22 approaches to the discharge ports 26a and 26b (that is, vane 23), the fluid is compressed and its pressure gets higher. Accordingly, the first clearance 410 is preferably formed in the vicinity of any one of the discharge ports 26a and 26b so as to effectively leak the compressed fluid in rotation of the driving shaft 13 in any one direction. Substantially, if the first clearance 410 is spaced apart by α1 in the range of 60°-90° from the vane 23 clockwise or counterclockwise, it is proper to leak the fluid. FIG. 38 shows the first clearance 410 spaced apart by α1 counterclockwise. In addition, the first clearance 410 depends a little on the specification of the compressor and is preferably 90-100 μm.

Meanwhile, since the cylinder 21 has a circular inner circumference, the sum of clearances at the positions facing each other, i.e., the positions spaced apart by 180° from each other is constant. Accordingly, the sum of the first clearance 410 and the first facing clearance 410a formed at the position (A) facing the first clearance is also constant. As a result, the first facing clearance 410a is formed to be narrow and the first clearance 410 is formed to be large as about five times as the first facing clearance 410a. It is preferable that the first facing clearance 410a is substantially 20-30 μm. The entire clearance of about 120 μm is formed with the first clearance 410.

In addition, the clearance 400 to assist the first clearance 410 can further a second clearance 420 formed to be comparatively wide. The second clearance 420 is spaced apart by a predetermined angle from the first clearance 410 and actually spaced apart by the angle α2 in the range of 150°-180° from the vane 23. The second clearance 420 depends a little on the specification of the compressor and is preferably 90-100 μm similar to the first clearance. Similarly, the second clearance 420 has the second facing clearance 420a formed on the position B facing the second clearance 420 and the characteristics of the second facing clearance 420a is substantially the same as the first facing clearance 410a. So, the detailed description on the second facing clearance 420a will be omitted. Except for these clearances 410, 420, 410a and 420a, the other clearances are formed to be the same as their facing clearances.

Due to the clearances 410, 420, 410a and 420a, the clearances 400 vary along the inner circumference of the cylinder 21 and differ from each other at especially the vane 23, that is, around discharge ports 26a and 26b. More particularly, the clearance 400 is partially wide (clearances 410 and 420) at initial of the counterclockwise rotation of the driving shaft 13 and is partially narrow (clearances 410a and 420a) at last of the counterclockwise rotation of the driving shaft 13. The clearance 400 is partially narrow (clearances 410a and 420a) at initial of the clockwise rotation of the driving shaft 13 and is partially wide (clearances 410 and 420) at last of the clockwise rotation of the driving shaft 13. Considering these, the clearances 400 are resultantly varied depending on the rotational direction of the driving shaft 13.

Meanwhile, as described above with reference to FIGS. 35 and 36, the suction ports 27a and 27b are individually connected with a plurality of suction pipes 7a so as to supply fluid to the fluid chamber 29 inside the cylinder 21. However, these suction pipes 7a increase the number of parts, thus making the structure complicated. Also, fluid may not be properly supplied to the cylinder 21 due to a change in a compression state of the suction pipes 7b separated during operation. Accordingly, as expressed by a dotted line on FIG. 35, it is desirable that the compressor includes a suction plenum 500 for preliminarily storing fluid to be sucked by the compressor. Such the suction plenum 500 forms a space in which a predetermined amount of fluid is always stored, so that a pressure variation of the sucked fluid is buffered to stably supply the fluid to the suction ports 27a, 27b and 27c. In addition, the suction plenum 500 can accommodate oil extracted from the stored fluid and thus assist or substitute for the accumulator 8.

Hereinafter, operation of a rotary compressor according to a fourth embodiment of the present invention will be described in more detail.

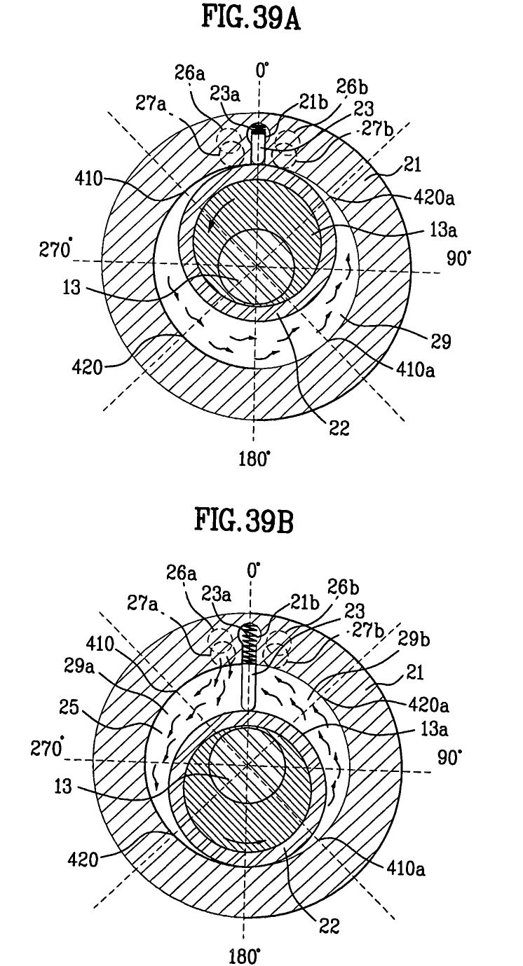

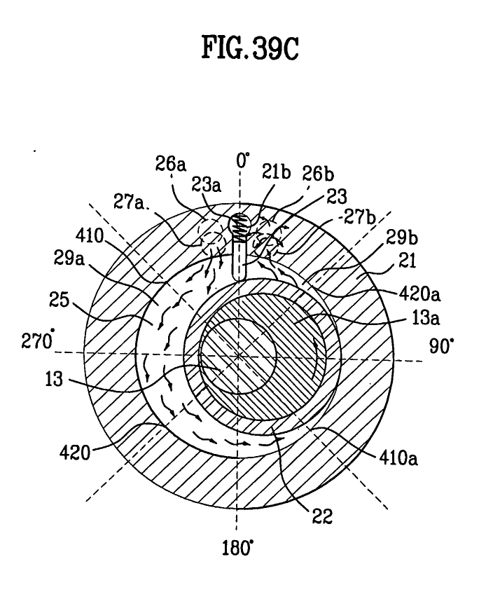

FIGS. 39A to 39C are cross-sectional views sequentially illustrating insides of the cylinder when the roller revolves in the counterclockwise direction in the rotary compressors according to a fourth embodiment of the present invention.

First, in FIG. 39A, there are shown states of respective elements inside the cylinder when the driving shaft 13 begins to rotate in the counterclockwise direction. Since there is no pressure variation in the cylinder 21, the suction and discharge ports are closed by the respective valves. Since operations of the respective valves in the counterclockwise rotation have been described in the above, its detailed description will be omitted.

The roller 22 revolves counterclockwise with performing a rolling motion along the inner circumference of the cylinder 21 due to the rotation of the driving shaft 13. As the roller 22 continues to revolve, the size of the space 29b is reduced as shown in FIG. 39B and thus the fluid that has been sucked is compressed. Due to the compression, a positive pressure is generated in the space 29b and accordingly the second port 27b is more firmly closed. At the same time, as a negative pressure is generated in the space 29a, the first suction port 27a is opened and the first discharge port 26a is closed. New fluid continues to be sucked into the space 29a through the first suction port 27a so as to be compressed in a next stroke. In this stroke, the vane 23 moves up and down elastically by the elastic member 23a to thereby hermetically partition the fluid chamber 29 into the two sealed spaces 29a and 29b. Also, since the first facing clearance 410a is formed narrower than other surrounding clearances, the compressed fluid having a high pressure can be continuously compressed without being leaked to the clearance.

When the fluid pressure in the space 29b is above a predetermined value, the second discharge port 26b is opened and as shown in FIG. 39C, the fluid is discharged through the second discharge port 26b. As the roller 22 continues to revolve, all the fluid in the space 29b is discharged through the second discharge port 26b. Herein, the pressure of the fluid shows the highest value but since the second facing clearance 420a is narrower than other surrounding clearances, the fluid can be discharged stably. After the fluid is completely discharged, the second discharge valve 26d closes the second discharge port 26c by its self-elasticity.

Thus, after a single stroke is ended, the roller 22 continues to revolve counterclockwise and discharges the fluid by repeating the same stroke. In the counterclockwise stroke, the roller 22 compresses the fluid with revolving from the first suction port 27a to the second discharge port 26b. As aforementioned, since the first suction port 27a and the second discharge port 27b are positioned in the vicinity of the vane 23 to face each other, the fluid is compressed using the overall volume of the fluid chamber 29 in the counterclockwise stroke and thus a maximal compression capacity is obtained.

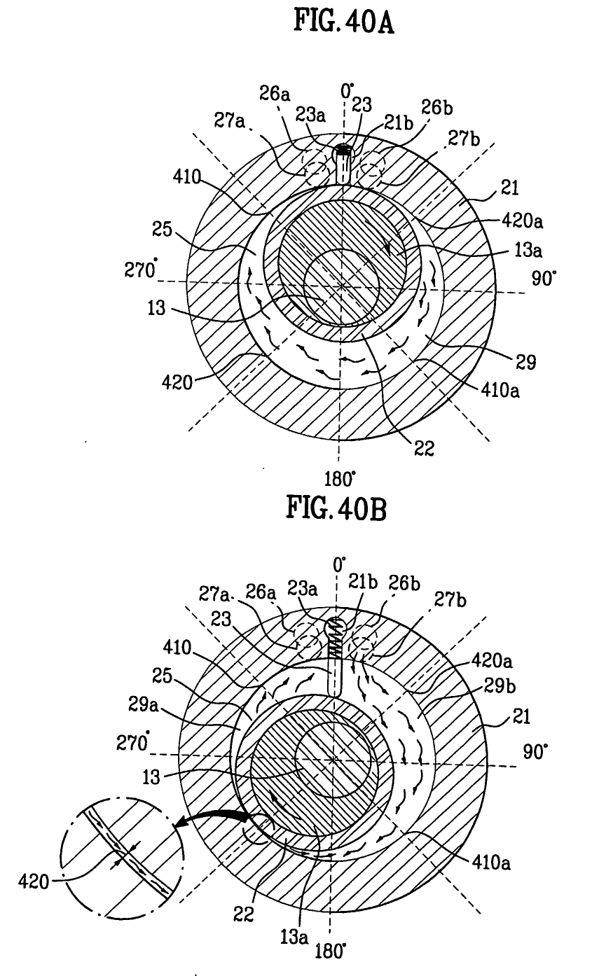

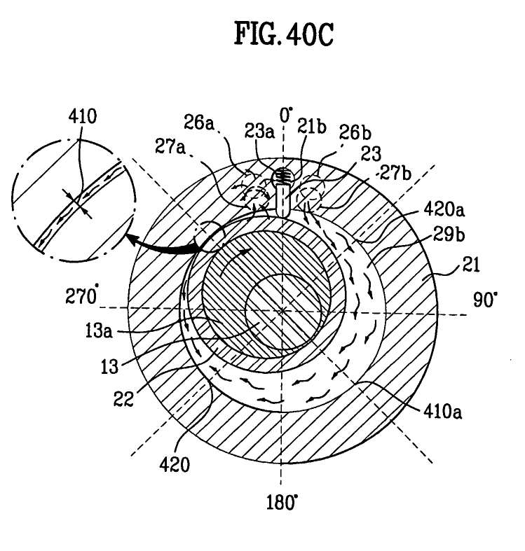

FIGS. 40A to 40C are cross-sectional views sequentially illustrating insides of the cylinder when the roller revolves in the clockwise direction in the rotary compressors according to a fourth embodiment of the present invention.

First, in FIG. 40A, there are shown states of respective elements inside the cylinder when the driving shaft 13 rotates in the clockwise direction. Since there is no pressure variation in the cylinder 21, the suction and discharge ports are closed by the respective valves as aforementioned. Since operations of the respective valves in the counterclockwise rotation have been described in advance in the above, its detailed description will be omitted.

The roller 22 begins to revolve clockwise with performing a rolling motion along the inner circumference of the cylinder 21 due to the rotation of the driving shaft 13. By such an initial stage revolution, the size of the space 29a is reduced and the fluid in the space 29a is gradually compressed such that pressure is elevated. In this compression stroke, the vane 23 moves up and down elastically by the elastic member 23a to thereby partition the fluid chamber 29 into the two sealed spaces 29a and 29b. At the same time, the space 29a becomes a positive pressure state relatively and accordingly, the first suction port 27a is closed such that the compressed fluid is not leaked. However, as shown in FIG. 40B, since the first clearance 410 is formed wider than other surrounding clearances while the roller 22 revolves, a part of the fluid which compression is initiated is leaked through the clearance 410. Accordingly, pressure as well as fluid amount in the space 29a decreases considerably.

When the fluid pressure in the space 29a is above a predetermined value, the first discharge port 26a is opened as shown in FIG. 40C and accordingly the fluid is discharged through the first discharge port 26a. Herein, the fluid shows the highest pressure value but since the first clearance 410 is formed wider than other surrounding clearances, the leakage of the fluid is generated more seriously than in the second clearance 420. After the fluid is completely discharged, the first discharge valve 26c closes the first discharge port 26a by its self-elasticity.

Thus, after a single stroke is ended, the roller 22 continues to revolve clockwise and discharges the fluid by repeating the same stroke. In the clockwise stroke, the roller 22 compresses the fluid with revolving from the second suction port 27b to the first discharge port 26a. Accordingly, like the counterclockwise stroke, the fluid in the clockwise stroke is compressed using the entire portion of the fluid chamber 29. However, much fluid is leaked due to the first and second clearances 410 and 420. Accordingly, in the counterclockwise stroke, a compression capacity that is smaller than that in the clockwise direction is obtained, which brings the same result as that of when the fluid is compressed only using a part of the entire fluid chamber 29.

In the aforementioned strokes (i.e., the clockwise stroke and the counterclockwise stroke), the discharged compressive fluid moves upward through the space between the rotor 12 and the stator 11 inside the case 1 and the space between the stator 11 and the case 1. Finally, the compressed fluid is discharged through the discharge pipe 9 out of the compressor.

In the aforementioned fourth embodiment, the inventive rotary compressor has suction and discharge ports for sucking and discharging fluid in bidirectional rotation of the driving shaft, and clearances located between the roller and the cylinder and varied with the rotational direction of the driving shaft. Accordingly, due to these clearances, fluid may be leaked while the fluid is compressed in a specific rotational direction, which causes a result that the fluid is compressed using the entire portion of the fluid chamber in any one directional rotation and is compressed using a part of the fluid chamber in other directional rotation. Accordingly, the fluid can be compressed although the driving shaft rotates in any one of the counterclockwise direction and clockwise direction. Also, different sizes of compression spaces are formed depending on the rotational direction of the driving shaft such that different compression capacities are obtained in its operation. In particular, any one of the compression capacities is formed using the predesigned entire fluid chamber.

It will be apparent to those skilled in the art that various modifications and variations can be made in the present invention. Thus, it is intended that the present invention covers the modifications and variations of this invention provided they come within the scope of the appended claims and their equivalents.

### INDUSTRIAL APPLICABILITY

The rotary compressor constructed as above has following effects.

First, according to the related art, several devices are combined in order to achieve the dual-capacity compression. For example, an inverter and two compressors having different compression capacities are combined in order to obtain the dual compression capacities. In this case, the structure becomes complicated and the cost increases. However, according to the present invention, the dual-capacity compression can be achieved using only one compressor. Particularly, the present invention can achieve the dual-capacity compression by changing parts of the conventional rotary compressor to the minimum.

Second, the conventional compressor having a single compression capacity cannot provide the compression capacity that is adaptable for various operation conditions of air conditioner or refrigerator. In this case, power consumption may be wasted unnecessarily. However, the present invention can provide a compression capacity that is adaptable for the operation conditions of equipments.

Third, the rotary compressor of the present invention uses the entire portion of the predesigned fluid chamber in producing a dual-compression capacity. This means that the compressor of the present invention has at least the same compression capacity as the conventional rotary compressor having the same sized cylinder and fluid chamber. In other words, the inventive rotary compressor can substitute for the conventional rotary compressor without modifying designs of basic parts, such as cylinder size or the like. Accordingly, the inventive rotary compressor can be freely applied to required systems without any consideration of the compression capacity and any increase in unit cost of production.

1. A rotary compressor having two different compression capacities in clockwise and counterclockwise directions, comprising:
a driving shaft being rotatable clockwise and counterclockwise, and having an eccentric portion of a predetermined size;
a cylinder having a predetermined inner volume;
a roller installed rotatably on an outer circumference of the eccentric portion so as to contact an inner circumference of the cylinder, performing a rolling motion along the inner circumference and forming a fluid chamber to suck and compress fluid along with the inner circumference;
a vane installed elastically in the cylinder to contact the roller;
upper and lower bearings installed respectively in upper and lower portions of the cylinder, for rotatably supporting the driving shaft and hermetically sealing the inner volume;
suction and discharge ports communicating with the fluid chamber so as to suck and discharge the fluid; and
a compression mechanism configured to form different sizes of compressive spaces in the fluid chamber depending on the rotational direction of the driving shaft.

2. The rotary compressor of claim 1, wherein the compression mechanism compresses the fluid using the overall fluid chamber when the driving shaft rotates in any one of the clockwise direction and the counterclockwise direction.

3. The rotary compressor of claim 1, wherein the compression mechanism compresses the fluid using a portion of the fluid chamber when the driving shaft rotates in the other of the clockwise direction and the counterclockwise direction.

4. The rotary compressor of claim 1, wherein the suction ports are configured to suck the fluid in all the rotational directions of the driving shaft.

5. The rotary compressor of claim 1, wherein the discharge ports are configured to discharge the fluid which is introduced from a corresponding one of the suction ports and compressed while the driving shaft rotates clockwise or counterclockwise.

6. The rotary compressor of claim 1, wherein the suction ports are spaced apart by a predetermined angle from each other.

7. The rotary compressor of claim 1, wherein the discharge ports are spaced apart by a predetermined angle from each other.

8. The rotary compressor of claim 1, wherein each of the suction and discharge ports is at least two.

9. The rotary compressor of claim 1, wherein the compression mechanism comprises a valve assembly, which rotates according to the rotational direction of the driving shaft to selective open at least one of the suction ports.

10. The rotary compressor of claim 9, wherein the discharge ports comprise a first discharge port and a second discharge port which are positioned facing each other with respect to the vane.

11. The rotary compressor of claim 9, wherein the suction ports comprise a first suction port located in the vicinity of the vane and a second suction port spaced apart by a predetermined angle from the first suction port.

12. The rotary compressor of claim 11, wherein the suction ports are circular.

13. The rotary compressor of claim 11, wherein the suction ports are rectangles.

14. The rotary compressor of claim 13, wherein the suction ports have a predetermined curvature.

15. The rotary compressor of claim 12, wherein the suction ports have diameters ranged from 6 mm to 15 mm.

16. The rotary compressor of claim 11, wherein the first suction port is positioned spaced by approximately 10° from the vane clockwise or counterclockwise.

17. The rotary compressor of claim 11, wherein the second suction port is positioned in a range of 90-180° from the vane to face the first suction port.

18. The rotary compressor of claim 9, further comprising discharge valves opening and closing the discharge ports so as to discharge the compressed fluid through the corresponding suction ports.

19. The rotary compressor of claim 9, wherein the valve assembly comprises: a first valve installed rotatably between the cylinder and the bearing; and a second valve for guiding a rotary motion of the first valve.

20. The rotary compressor of claim 19, wherein the first valve comprises a disc member contacting the eccentric portion of the driving shaft and rotating in the rotational direction of the driving shaft.

21. The rotary compressor of claim 20, wherein the first valve has a diameter larger than an inner diameter of the cylinder.

22. The rotary compressor of claim 20, wherein the first valve is 0.5-5 mm thick.

23. The rotary compressor of claim 19, wherein the first valve comprises: a first opening communicating with the first suction port when the driving shaft rotates in any one of the clockwise direction and the counterclockwise direction; and a second opening communicating with the second suction port when the driving shaft rotates in the other of the clockwise direction and the counterclockwise direction.

24. The rotary compressor of claim 19, wherein the first valve comprises a single opening communicating with the first suction port when the driving shaft rotates in any one of the clockwise direction and communicating with the second suction port when the driving shaft rotates in the other of the clockwise direction the counterclockwise direction.

25-32. (canceled)

33. The rotary compressor of claim 23, wherein the suction port further comprises a third suction port positioned between the second suction port and the vane.

34. The rotary compressor of claim 33, wherein the third suction port is spaced apart by 10° clockwise or counterclockwise from the vane so as to face the first suction port.

35. The rotary compressor of claim 33, wherein the first valve further comprises a third opening for opening the third suction port simultaneously with opening the second suction port.

36. The rotary compressor of claim 33, wherein the first valve comprises a first opening for opening the third suction port simultaneously with opening the second suction port.

37. The rotary compressor of claim 19, wherein the valve assembly further comprises means for controlling a rotation angle of the first valve such that corresponding suction ports are opened accurately.

38. The rotary compressor of claim 37, wherein the control means comprises: a curved groove formed at the first valve and having a predetermined length; and a stopper formed on the bearing and inserted into the curved groove.

39. The rotary compressor of claim 38, wherein the curved groove is positioned in the vicinity of a center of the first valve.

40. The rotary compressor of claim 38, wherein the stopper has the same thickness as the first valve.

41. The rotary compressor of claim 38, wherein the stopper has the same width as the curved groove.

42. The rotary compressor of claim 38, wherein the curved groove has an angle of 30-120° between both ends thereof.

43. The rotary compressor of claim 37, wherein the control means comprises: a projection formed on the first valve and projecting in a radial direction of the first valve; and a groove formed on the second valve, for receiving the projection movably.

44. The rotary compressor of claim 37, wherein the control means comprises: a projection formed on the second valve and projecting in a radial direction of the second valve; and a groove formed on the first valve, for receiving the projection movably.

45. The rotary compressor of claim 37, wherein the control means comprises: a projection formed on the second valve and projecting toward a center of the second valve; and a cut-away portion formed on the first valve, for receiving the projection movably.

46. The rotary compressor of claim 45, wherein the projection and the cut-away portion form a clearance therebetween and the clearance opens the first suction port or the third suction port according to the rotational direction of the driving shaft.

47. The rotary compressor of claim 45, wherein the projection has an angle of 10-90° between both side surfaces thereof.

48. The rotary compressor of claim 45, wherein the cut-away portion has an angle of 30-120° between both ends thereof.

49. The rotary compressor of claim 1, wherein the compression mechanism comprises a valve assembly selective opening at least one of the suction ports spaced apart from each other by using a pressure difference between the cylinder and inner and outer portions according to the rotational direction of the driving shaft.

50. (canceled)

51. The rotary compressor of claim 49, wherein the suction ports comprise a first suction port located in the vicinity of the vane and a second suction port spaced apart by a predetermined angle from the first suction port.

52-56. (canceled)

57. The rotary compressor of claim 49, wherein the valve assembly comprises: a first valve installed rotatably between the cylinder and the bearing; and a second valve for guiding a rotary motion of the first valve.

58. The rotary compressor of claim 57, wherein the, first and second valves are configured to open the second suction port by an inner negative pressure of the cylinder.

59. The rotary compressor of claim 58, wherein the first and second valves are a check valve allowing only a flow of the fluid into the inside of the cylinder.

60. The rotary compressor of claim 58, wherein the first and second valves are a plate valve, which is deformed so as to open the suction port by a pressure difference.

61. The rotary compressor of claim 60, wherein the first and second valves are deformed so as to open the suction port in a direction which the negative pressure is generated.

62. The rotary compressor of claim 60, wherein a predetermined clearance is formed between the second valve and the second suction port.

63. The rotary compressor of claim 60, wherein the first and second valves further comprise a retainer to restrict deformation thereof.

64-70. (canceled)

71. The rotary compressor of claim 1, wherein the compression mechanism is comprised of a first vane and a second vane that divide the fluid chamber into a first space configured such that the fluid is compressed while the driving shaft rotates bidirectionally, and a second space configured such that the fluid is compressed while the driving shaft rotates in any one direction.

72-74. (canceled)

75. The rotary compressor of claim 71, wherein the suction and discharge ports supply or discharge the fluid into the first and second spaces selectively depending on the rotational direction of the driving shaft.

76. The rotary compressor of claim 75, wherein the suction and discharge ports are configured to suck the fluid into the first space in all the rotational directions of the driving shaft and discharge the compressed fluid from the first space.

77. The rotary compressor of claim 76, wherein the discharge ports are located communicating with the first space and comprises first and second discharge ports discharging the compressed fluid in each of the rotational directions of the driving shaft.

78-99. (canceled)

100. The rotary compressor of claim 1, wherein the compression mechanism is comprised of clearances formed differently according to the rotational direction of the driving shaft between the roller and the inner circumference of the cylinder.

101-109. (canceled)

110. The rotary compressor of claim 100, wherein the suction and discharge ports comprise suction and discharge valves, which are selectively opened or closed depending on the rotational direction of the driving shaft.

111. The rotary compressor of claim 110, wherein the suction valves are configured to open the suction ports by an inner negative pressure of the cylinder.

112. The rotary compressor of claim 110, wherein the discharge valves are configured to open the discharge ports by an inner positive pressure of the cylinder.

113. The rotary compressor of claim 110, wherein the suction and discharge valves are a check valve allowing only a flow of the fluid into the inside of the cylinder.

114. The rotary compressor of claim 110, wherein the suction and discharge valves are a plate valve, which is deformed so as to open the suction port by a pressure difference.

115. The rotary compressor of claim 114, wherein the suction and discharge valves further comprise a retainer to restrict deformation thereof.

116-131. (canceled)
